(19) United States
(12) Patent Application Publication
(10) Pub. No.: US 2014/0317444 A1
(43) Pub. Date: Oct. 23, 2014

(54) STORAGE CONTROL DEVICE AND STORAGE DEVICE

(71) Applicant: FUJITSU LIMITED, Kawasaki-shi (JP)

(72) Inventors: Jiyu KUSHIHARA, Kawasaki (JP); Daiya Nakamura, Kawasaki (JP); Kazuma Takatsu, Yokohama (JP)

(73) Assignee: FUJITSU LIMITED, Kawasaki-shi (JP)

(21) Appl. No.: 14/190,703

(22) Filed: Feb. 26, 2014

(30) Foreign Application Priority Data
Apr. 22, 2013 (JP) 2013-089235

(51) Int. Cl. G06F 3/06

(52) U.S. Cl. CPC G06F 3/0619; G06F 3/065; G06F 3/0653; G06F 3/0689
USPC 714/6.22

(57) ABSTRACT

A storage control device includes a processor. The processor is configured to monitor driving states of each of a plurality of storage drives included in a storage device. The processor is configured to rearrange data stored in the storage drives so that the driving states of the storage drives are uniformed.

### CROSS-REFERENCE TO RELATED APPLICATION

This application is based upon and claims the benefit of priority of the prior Japanese Patent Application No. 2013-089235, filed on Apr. 22, 2013, the entire contents of which are incorporated herein by reference.

### FIELD

The embodiments discussed herein are related to a storage control device and a storage device.

### BACKGROUND

Storage devices such as redundant arrays of inexpensive disks (RAID) devices include a large number of disks (storage drives). Such a RAID device includes a plurality of RAID groups and a plurality of volumes as illustrated in FIG. 23, for example, and access frequencies of the individual volumes may be different. In this case, since access frequencies of the RAID groups are different from one another, use frequencies of the disks are also different from one another depending on the RAID groups to which the disks belong. Consequently, degrees of wear and deterioration of disks included in a specific one of the RAID groups become larger than those of the other disks, and failure probabilities of the disks which belong to the specific RAID group become higher than those of the other disks. Accordingly, non-uniformity of the probabilities of failure of the disks is generated.

Furthermore, in recent years, a large number of storage devices have a function of setting an economy mode of turning off driving motors of disks included in RAID groups (or blocking power supply to driving motors) in accordance with schedules specified by users. When the economy mode is entered, the number of times the driving motor of each disk included in a device are turned off/on (that is, the number of times an off state is switched to an on state or the number of times an on state is switched to an off state) becomes non-uniform. Therefore, failure probabilities of the disks also become non-uniform.

A technique of measuring access frequencies of individual volumes or individual pages and changing data allocation to the volumes or the pages so that the frequencies of access to the volumes or the pages are uniformed has been proposed. However, even if such a technique is applied to the RAID devices, as with the case described above, non-uniformity of the failure probabilities of the disks is generated.

A related technique is disclosed in, for example, Japanese Laid-open Patent Publication No. 2009-43016.

When the failure probabilities of the disks are non-uniform, a specific one of the disks fails in a comparatively short period of time, and therefore, availability of the RAID device is deteriorated. Furthermore, a period (referred to as a failure period) of time from when a disk is mounted to when the disk fails varies depends on the disks, and therefore, it is difficult to estimate a timing when disk replacement is performed and to prepare for the disk failure (preparation for the disk replacement, for example).

### SUMMARY

According to an aspect of the present invention, provided is a storage control device including a processor. The processor is configured to monitor driving states of each of a plurality of storage drives included in a storage device. The processor is configured to rearrange data stored in the storage drives so that the driving states of the storage drives are uniformed.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating hardware configurations of a storage device and a storage control device according to an embodiment;

FIG. 2 is a block diagram illustrating a functional configuration of the storage control device;

FIG. 3 is a diagram illustrating a process of tabulating driving states monitored by a monitoring unit;

FIG. 4 is a diagram concretely illustrating examples of results of the tabulation of the driving states monitored by the monitoring unit;

FIG. 5 is a diagram illustrating a concrete example of a replacement source disk list according to the embodiment;

FIG. 6 is a diagram illustrating concrete examples of replacement destination disk lists according to the embodiment;

FIG. 7 is a diagram illustrating a concrete example of a replacement disk list according to the embodiment;

FIG. 8 is a diagram illustrating a concrete example of a determination list according to the embodiment;

FIG. 9 is a flowchart illustrating operation of a rearrangement control unit;

FIG. 10 is a flowchart illustrating operation of a data replacement disk selection unit;

FIG. 11 is a flowchart illustrating operation of a replacement source disk list generation unit and operation of a replacement destination disk list generation unit;

FIG. 12 is a flowchart illustrating operation of a replacement disk list generation unit;

FIG. 13 is a diagram illustrating operation of the replacement disk list generation unit;

FIG. 14 is a diagram illustrating a concrete example of a buffer disk flag list according to the embodiment;

FIG. 15 is a flowchart illustrating operation of a data replacement disk determination unit;

FIG. 16 is a diagram illustrating an example of a correspondence table generated by an estimation unit;

FIGS. 17A to 17E are diagrams illustrating operation of a timing control unit;

FIG. 18 is a flowchart illustrating operation of the timing control unit;

FIGS. 19A and 19B are diagrams illustrating detailed operation of a data replacement control unit according to the embodiment;

FIGS. 20A to 20C are diagrams illustrating the detailed operation of the data replacement control unit according to the embodiment;

FIGS. 21A to 21C are diagrams illustrating the detailed operation of the data replacement control unit according to the embodiment;

FIGS. 22A to 22C are diagrams illustrating the detailed operation of the data replacement control unit according to the embodiment; and

FIG. 23 is a diagram illustrating the relationships between use frequencies and degrees of wear of disks in a RAID device.

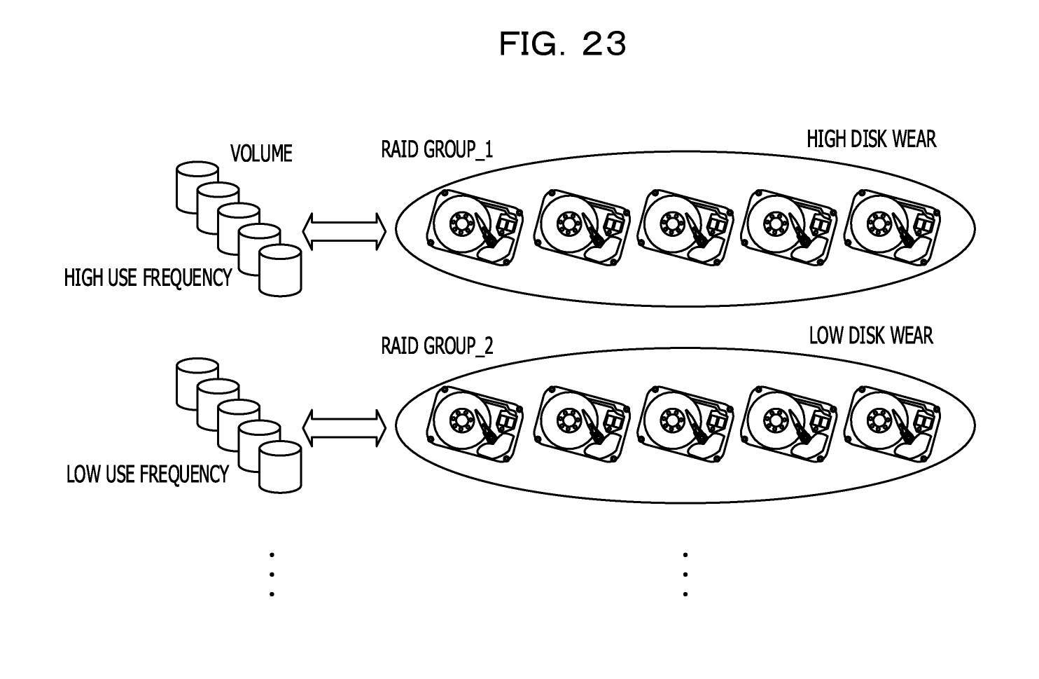

### DESCRIPTION OF EMBODIMENTS

Hereinafter, embodiments will be described with reference to the accompanying drawings.

### First Embodiment

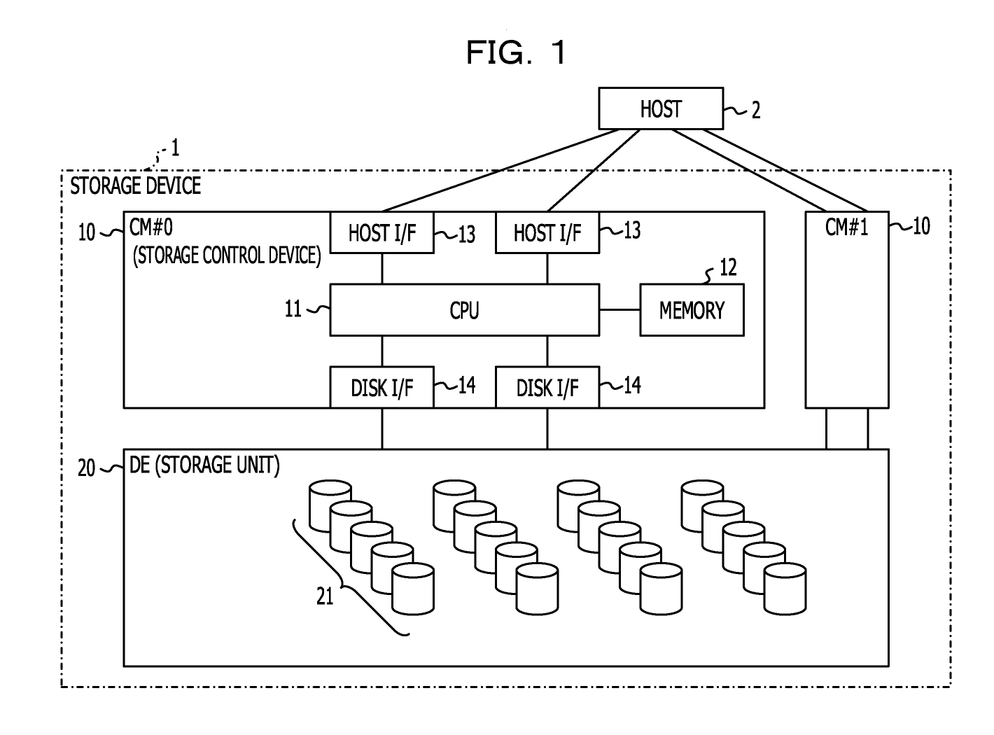

FIG. 1 is a block diagram illustrating hardware configurations of a storage device 1 and a storage control device 10 according to a first embodiment.

As illustrated in FIG. 1, the storage device 1 of the first embodiment, which is a disk array device (a RAID device), for example, receives various requests from a host computer (simply referred to as a “host”) 2 and performs various processes in response to the requests. The storage device 1 includes controller modules (CMs) 10 and a disk enclosure (DE) 20. The storage device 1 illustrated in FIG. 1 includes two CMs 10, that is, a CM#0 and a CM#1. Although only a configuration of the CM#0 is illustrated in FIG. 1, the CM#1 has the same configuration as the CM#0. The number of the CMs 10 is not limited to two, and one, three, or more CMs 10 may be included in the storage device 1. The DE (storage unit) 20 includes a plurality of disks 21. Each of the disks 21 is a hard disk drive (HDD), that is, a storage drive, for example, and accommodates and stores therein user data and various control information to be accessed and used by the host computer 2.

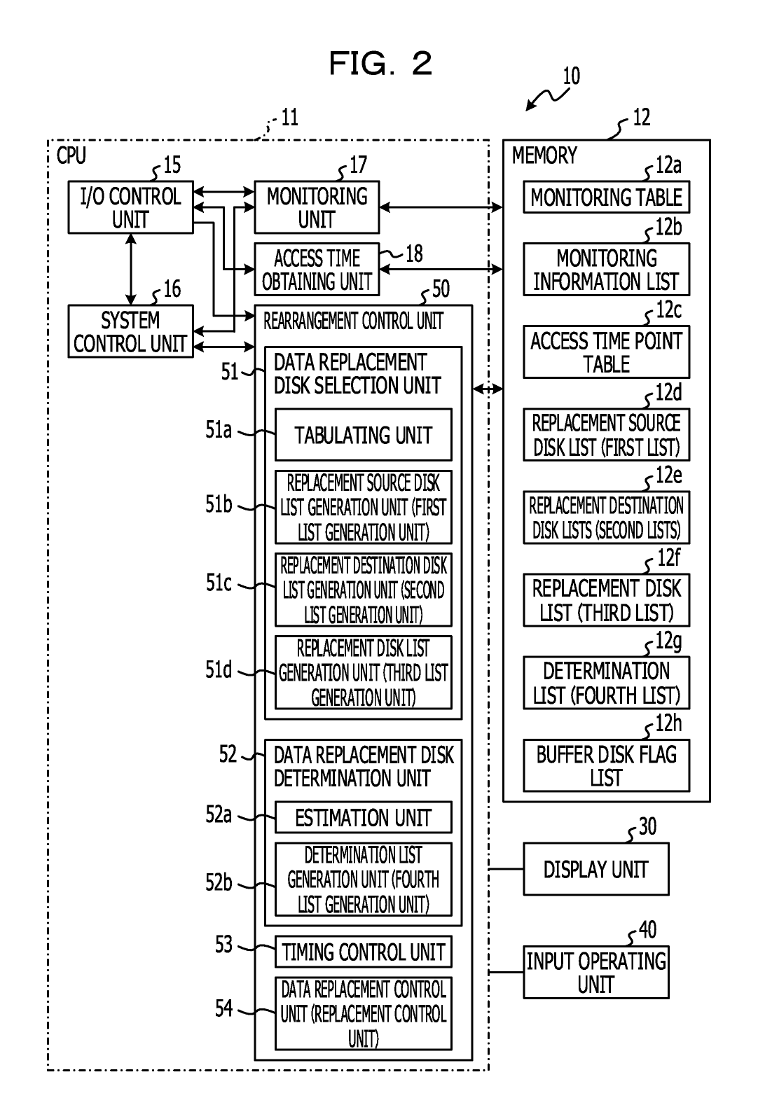

The CM (storage control device) 10 is disposed between the host computer 2 and the DE 20 and manages resources in the storage device 1. The CM 10 includes a central processing unit (CPU) 11, a memory 12, host interfaces (I/Fs) 13, and disk I/Fs 14. The CPU (a processing unit or a computer) 11 performs various control operations by executing processes in accordance with an operating system (OS) or the like and functions as described below with reference to FIG. 2 by executing programs stored in the memory 12. The memory 12 stores therein, in addition to the programs, various data including tables 12a and 12c, lists 12b, 12d, 12e, 12f, 12g, and 12h, and the like which will be described later with reference to FIG. 2. Furthermore, the memory 12 also functions as a cache memory which temporarily stores therein data to be written from the host computer 2 to the disks 21 and data to be read from the disks 21 to the host computer 2.

The host I/Fs 13 perform interface control between the host computer 2 and the CPU 11 and are used to perform data communication between the host computer 2 and the CPU 11. The disk I/Fs 14 perform interface control between the DE 20 (the disks 21) and the CPU 11 and are used to perform data communication between the DE 20 (the disks 21) and the CPU 11. The storage device 1 illustrated in FIG. 1 includes two host I/Fs 13 and two disk I/Fs 14. The number of the host I/Fs 13 and the number of the disk I/Fs 14

Fujitsu Ref. No.: 12-54803 are not limited to two, and one, three, or more host I/Fs 13 or disk I/Fs 14 may be included in the storage device 1.

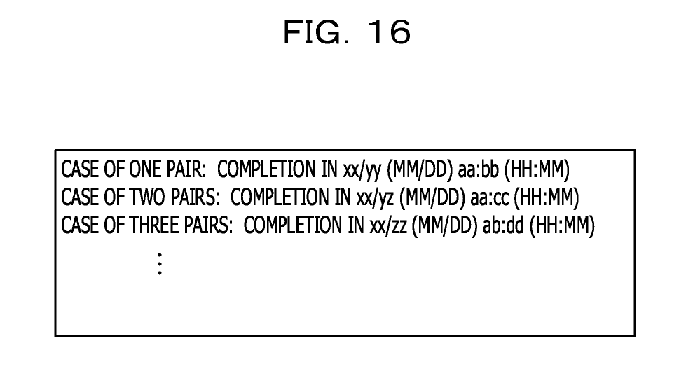

The storage device 1 of the first embodiment further includes a display unit 30 (refer to FIG. 2) and an input operating unit 40 (refer to FIG. 2). The display unit 30 displays, for a user, a correspondence table (refer to FIG. 16) generated by a data replacement disk determination unit 52 which will be described later with reference to FIG. 2. The display unit 30 is, for example, a liquid crystal display (LCD), a cathode ray tube (CRT), or the like. The input operating unit 40 is operated by the user, who refers to a display screen of the display unit 30, to input instructions to the CPU 11. The input operating unit 40 is, for example, a keyboard, a mouse, or the like.

Next, a functional configuration of the CM 10 according to the first embodiment will be described with reference to FIG. 2. FIG. 2 is a block diagram illustrating a functional configuration of the CM 10 illustrated in FIG. 1.

The CM 10 functions as at least an input/output (I/O) control unit 15, a system control unit 16, a monitoring unit 17, an access time obtaining unit 18, and a rearrangement control unit 50 by executing the programs described above.

The I/O control unit 15 performs control in accordance with an input/output request supplied from the host computer 2.

The system control unit 16 operates in cooperation with the control operation performed by the I/O control unit 15 so as to manage a configuration and a state of the storage device 1, manage RAID groups, perform off/on control of power of the disks 21, perform off/on control of driving motors of the disks 21, and perform spin-up/spin-down control of the disks 21.

The monitoring unit 17 monitors, for individual disks 21, a plurality of types of driving state value correlating with deterioration of the disks 21, as driving states (monitoring items) of the disks 21 included in the DE 20 of the storage device 1. As the above-mentioned driving state values, driving state values of monitoring items (al) to (a4) below are monitored, and results of the monitoring are stored in the memory 12 as a monitoring table 12a for each disk 21.

(a1) The number of times the power of each disk 21 is turned off/on: The number of times the power is off/on corresponds to the number of times power supply to an entire disk 21 is turned off/on, that is, the number of times switching from an off state to an on state is performed or the number of times switching from an on state to an off state is performed. The monitoring unit 17 monitors and obtains the number of times the power of each disk 21 is turned off/on in a predetermined period of time by monitoring off/on control performed by the system control unit 16 on each disk 21.

(a2) The number of times the driving motor of each disk 21 is turned off/on: The number of times the driving motor is turned off/on corresponds to the number of times power supply to the driving motor of a disk 21 is turned off/on, that is, the number of times switching from an off state to an on state is performed or the number of times switching from an on state to an off state is performed. The monitoring unit 17 monitors and obtains the number of times the driving motor of each disk 21 is turned off/on in a predetermined period of time by monitoring off/on control performed by the system control unit 16 on the driving motor of each disk 21.

(a3) The number of times spin-up and/or spin-down is performed by the driving motor of each disk 21: The spin-up is an operation of increasing rotation speed of a disk 21 and the spin-down is an operation of reducing the rotation speed of a disk 21. Accordingly, the number of times the spin-up is performed corresponds to the number of times the rotation speed of a disk 21 is increased and the number of times the spin-down is performed corresponds to the number of times the rotation speed of a disk 21 is reduced. The monitoring unit 17 monitors and obtains the number of times the spin-up/spin-down is performed on the driving motor of each disk 21 in a predetermined period of time by monitoring control of the spin-up/spin-down of each disk 21 performed by the system control unit 16.

(a4) The number (access frequency) of times access is performed to each disk 21: The number of times access is performed corresponds to the number of times access for writing is performed and/or the number of times access for reading is performed to a disk 21 by the host computer 2, and preferably the number of times access for writing is performed. The monitoring unit 17 monitors and obtains the number (access frequency) of times access is performed to each disk 21 in a predetermined period of time by monitoring control performed by the I/O control unit 15 in accordance with input/output requests supplied from the host computer 2.

In the first embodiment, a reason that replacement of data is performed on a disk basis as described below when the driving state values are non-uniform while the driving state values are monitored for individual disks as described above will be described as follows.

In the first embodiment, the number of times the driving motor of each disk 21 is turned off/on and the number of times the power of each disk 21 is turned off/on are monitored since failure probability of a disk 21 becomes higher if the driving motor of the disk 21 or the power of the disk 21 is frequently turned off/on. The temperature in a disk 21 changes when the state of the driving motor of the disk 21 or the state of the disk 21 transits from off state to on state or from on state to off state. When the temperature is increased or decreased, the air is expanded or constricted. Accordingly, air current is generated between the inside and the outside of the disk 21, and therefore, it is highly likely that dust, which is a cause of failure of disks 21, invades the disk 21. Furthermore, when the driving motor of a disk 21 is turned off or the power of the disk 21 is turned off, a head of the disk 21 may have contact with a platter. When the head is in contact with the platter, the lubrication film on the surface of the platter may be peeled and the platter may be harmed. Wear of the platter is one of fundamental factors of disk failure. Moreover, when a driving motor is repeatedly turned off/on, exhaustion of the driving motor may be enhanced. Accordingly, the number of times a driving motor is turned off/on and the number of times the power of a disk 21 is turned off/on affect the life of the disk 21 and serve as driving state values correlating with the deterioration states of the disk (storage drive) 21. The number of times the driving motor of a disk 21 performs spin-up/spin-down and the number of times the disk 21 is accessed also affect the life of the disk 21 and serve as driving state values correlating with the deterioration states of the disk 21 similarly to the number of times the driving motor of the disk 21 is turned off/on and the number of times the power of the disk 21 is turned off/on.

When the technique of monitoring access frequencies for individual volumes or for individual pages described above is employed, the driving state values are not monitored for individual disks. If the driving state values of all the disks 21 included in the storage device 1 are the same as one another, monitoring of the driving state values for individual disks may not be important. However, as described above, when the economy mode is entered, the numbers of times the driving motors of individual disks 21 are turned off/on in the storage device 1 are not the same as one another, and the numbers of times the power of individual disks 21 are turned off/on in the storage device 1 are not the same as one another. In the economy mode, as described above, disks included in RAID groups are made to be a power-saving mode (that is, driving motors are turned off or power supply to the driving motors is blocked) in accordance with schedules specified by the user. Such an economy mode has been implemented in a large number of storage devices and widely used in recent years. When the economy mode is on, frequencies of accesses to volumes or pages are not proportional to failure probabilities of disks 21. Accordingly, in order to uniform the failure probabilities of individual disks 21 in the storage device 1, the driving state values are monitored for individual disks 21.

In the first embodiment, by performing monitoring and data exchange (data replacement) on a disk basis, failure probabilities of individual disks 21 are uniformed and failure intervals of the disks are uniformed even in the economy mode.

The access time obtaining unit 18 obtains access time points corresponding to accesses to the disks 21 by monitoring control performed by the I/O control unit 15 in accordance with input/output requests supplied from the host 2. The access time obtaining unit 18 stores the access time points obtained for individual disks 21 in the memory 12 as an access time point table 12c. By this, time zones (time points) of accesses from the host 2 are stored in the access time point table 12c for individual disks 21.

The rearrangement control unit 50 rearranges data stored in the disks 21 so that driving states of the disks 21 monitored by the monitoring unit 17 are uniformed. More specifically, the rearrangement control unit 50 selects two disks 21 which have different driving states on the basis of the driving state values of the monitoring items (al) to (a4) stored in the monitoring table 12a and replaces data stored in the selected two disks 21 with each other. The rearrangement control unit 50 has functions of a data replacement disk selection unit 51, the data replacement disk determination unit 52, a timing control unit 53, and a data replacement control unit 54 so as to perform the selection and the data replacement of the disks 21.

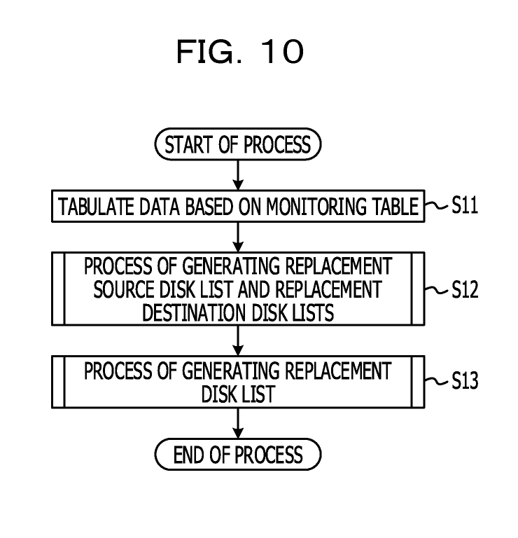

The data replacement disk selection unit 51 tabulates the driving state values of the monitoring items (al) to (a4) at a replacement start timing specified by the user and determines and selects a replacement source disk and a replacement destination disk which are a pair of disks 21 between which data is replaced with each another. Furthermore, the data replacement disk selection unit 51 selects a buffer disk to be used when the data replacement is performed between the selected replacement source disk and the selected replacement destination disk. Thereafter, the data replacement disk selection unit 51 generates a replacement disk list (a third list) 12f by associating identification information (ID) of the replacement source disk, ID of the replacement destination disk, and ID of the buffer disk with one another. The data replacement disk selection unit 51 has functions of a tabulating unit 51a, a replacement source disk list generation unit 51b, a replacement destination disk list generation unit 51c, and a replacement disk list generation unit 51d. Operation of the data replacement disk selection unit 51 will be described later in detail with reference to FIGS. 10 to 14.

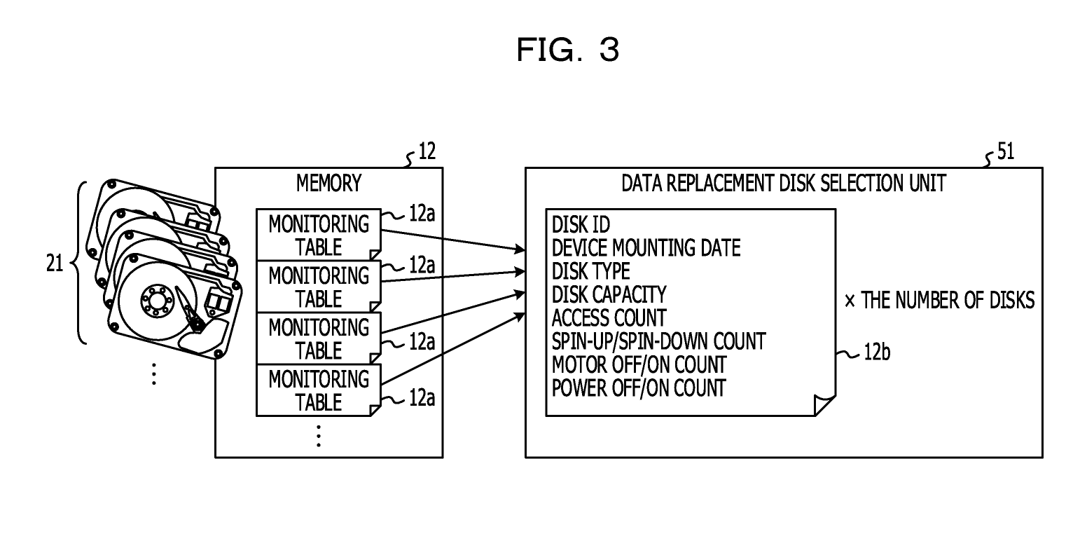

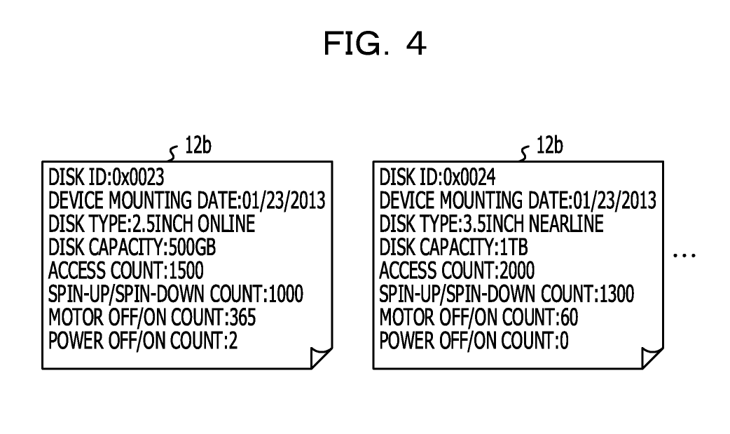

As illustrated in FIGS. 3 and 4, the tabulating unit 51a tabulates and generates a monitoring information list 12b for each disk 21 on the basis of the monitoring table 12a obtained by the monitoring unit 17. FIG. 3 is a diagram illustrating a process of tabulating driving states monitored by the monitoring unit 17. FIG. 4 is a diagram concretely illustrating results (the monitoring information lists 12b) of the tabulation of the driving states monitored by the monitoring unit 17. In the monitoring information list 12b generated for each disk 21, following items (b1) to (b8) are registered as illustrated in FIGS. 3 and 4. Counts (the driving state values) of the items (b5) to (b8) are obtained as results of counting performed in a period of time from the time point specified by the user to start a preceding process (that is, when the process is executed by the rearrangement control unit 50) to the time point currently specified by the user to start a current process, for example.

(b1) A disk ID for identifying a disk 21

(b2) A mounting date (on which the disk is mounted)

(b3) A type of the disk

(b4) Capacity of the disk

(b5) The number of times power is off/on (the monitoring item (a1) described above)

(b6) The number of times a driving motor is turned off/on (the monitoring item (a2) described above)

(b7) The number of times a driving motor performs spin-up/spin-down (the monitoring item (a3) described above)

(b8) The number of times access is performed (the monitoring item (a4) described above)

The replacement source disk list generation unit (a first list generation unit) 51b refers to the monitoring information lists 12b generated for individual disks 21 so as to calculate average values μ and standard deviations σ of the driving state values for individual monitoring items (types of driving state value) and calculates deviation values for the driving state values of the individual disks 21 for individual monitoring items. Furthermore, when at least one driving state value (a count) x among the driving state values of the monitoring items satisfies a predetermined data replacement condition, the replacement source disk list generation unit 51b selects a corresponding one of the disks 21 which records the driving state value x as a replacement source disk (an exchange source disk).

The predetermined data replacement condition is, for example, the driving state value x of a certain monitoring item of a certain disk 21 is not less than a value obtained by adding an average value μ and a standard deviation 6 of the driving state values of the monitoring item to each other, as denoted by Expression (1) below. In other words, when a deviation value for the driving state value (the count) x is not less than a predetermined value 60, a corresponding one of the disks 21 which records the driving state value x is selected as a replacement source disk which is a target of generation of a replacement source disk list (a first list) 12d which will be described below.

x≧μ+σ (1)

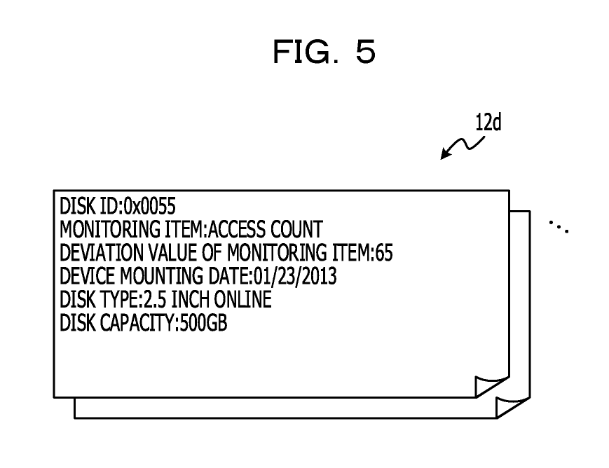

Furthermore, the replacement source disk list generation unit 51b generates the replacement source disk list (a first list) 12d in which items (c1) to (c6) below are associated with one another for the disks 21 (the replacement source disks) which satisfy the predetermined data replacement condition as illustrated in FIG. 5. When one of the disks 21 satisfies the predetermined data replacement condition in a plurality of monitoring items, the replacement source disk list generation unit 51b generates the replacement source disk list 12d using a monitoring item (a type of driving state value) having the largest deviation value. FIG. 5 is a diagram illustrating a concrete example of the replacement source disk list 12d according to the first embodiment.

(c1) A disk ID for identifying a disk 21

(c2) A monitoring item (information on a type of driving state value corresponding to the largest deviation value) serving as a factor of data replacement

(c3) A deviation value (the largest value in deviation values of types of driving state value calculated for the disk 21) for a driving state value of a monitoring item of (c2)

(c4) A mounting date (the item (b2) described above)

(c5) A type of the disk (the item (b3) described above)

(c6) Capacity of the disk (the item (b4) described above)

The number of elements of the replacement source disk list 12d corresponds to the number of disks 21 which satisfy the predetermined data replacement condition. When the number of elements is not less than 2, the replacement source disk list generation unit 51b sorts the elements of the replacement source disk list 12d in descending order of deviation values (largest values) of the item (c3). By this, as described below, the disks 21 which satisfy the predetermined data replacement condition are sequentially determined as replacement source disks in descending order of the deviation values.

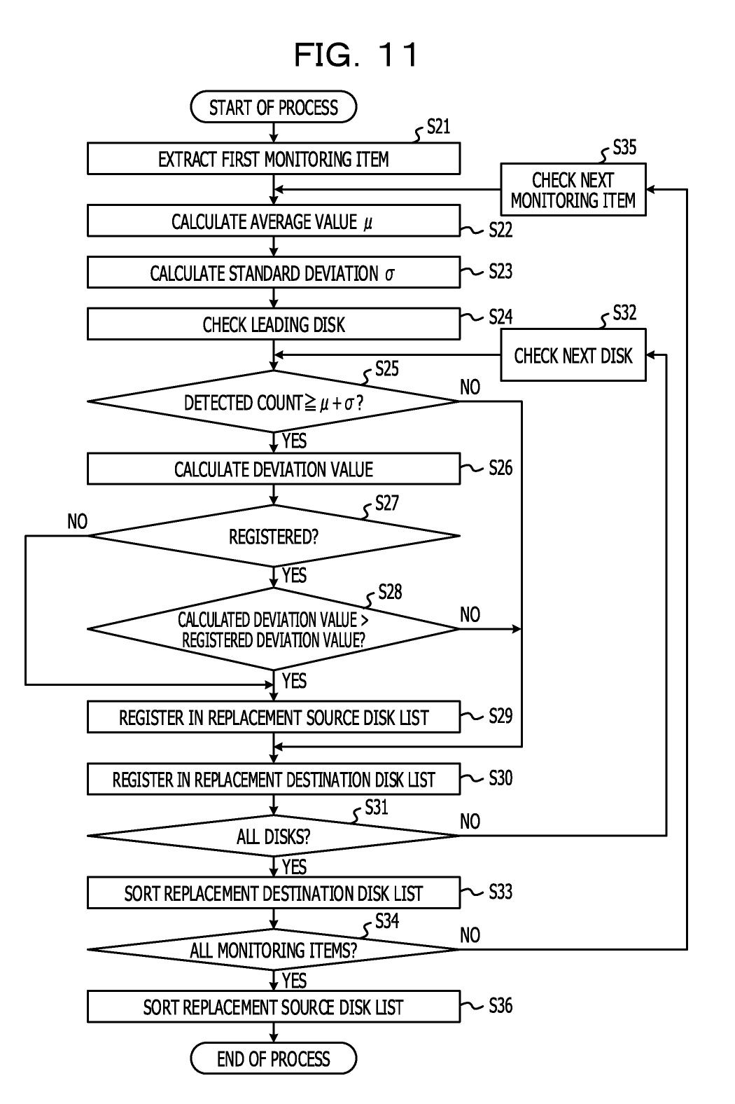

When no disk 21 satisfies the predetermined data replacement condition, the replacement source disk list 12d is not generated and the data replacement process is not performed. When one of the disks 21 satisfies the predetermined data replacement condition in only one of the monitoring items, the monitoring item and a deviation value for a driving state value corresponding to the monitoring item are registered in the items (c2) and (c3), respectively. Operation of the replacement source disk list generation unit 51b will be described later in detail with reference to FIG. 11.

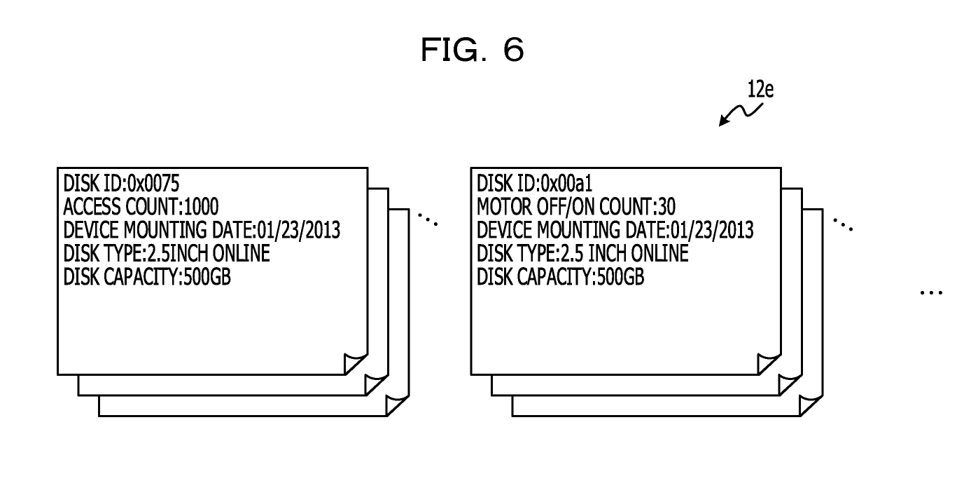

The replacement destination disk list generation unit (a second list generation unit) 51c generates a replacement destination disk list (a second list) 12e in which items (d1) to (d5) described below are associated with one another for each monitoring item (type of driving state value) as illustrated in FIG. 6. The replacement destination disk list 12e stores information on candidates for the replacement destination disk to determine the replacement destination disk which are to be subjected to data replacement with the replacement source disk specified by the replacement source disk list 12d. The replacement destination disk list 12e is generated for each monitoring item. FIG. 6 is a diagram illustrating concrete examples of the replacement destination disk lists 12e according to the first embodiment.

(d1) A disk ID for identifying a disk 21

(d2) The number (a driving state value) of times counted for a target monitoring item

(d3) A mounting date (the item (b2) described above)

(d4) A type of the disk (the item (b3) described above)

(d5) Capacity of the disk (the item (b4) described above)

The number of elements of the replacement destination disk list 12e generated for each monitoring item corresponds to the number of disks 21 mounted on the storage device 1. The replacement destination disk list generation unit 51c sorts the elements of the replacement destination disk list 12e generated for each monitoring item in ascending order of values of the item (d2) (driving state value (count) of the target monitoring item). By this, as described below, the disks 21 which are mounted on the storage device 1 are sequentially determined as replacement destination disks in ascending order of the driving state value. Operation of the replacement destination disk list generation unit 51c will be described later in detail with reference to FIG. 11.

The replacement disk list generation unit (a third list generation unit) 51d generates the replacement disk list 12f in which ID of a replacement source disk, ID of a replacement destination disk, and ID of a buffer disk are associated with one another on the basis of the replacement source disk list 12d and the replacement destination disk lists 12e. Here, the replacement disk list generation unit 51d sequentially reads disk IDs included in the replacement source disk list 12d from the top (in descending order of deviation values) and sequentially reads disk IDs included in the replacement destination disk list 12e corresponding to a monitoring item of the deviation values from the top (in ascending order of driving state values (counts)).

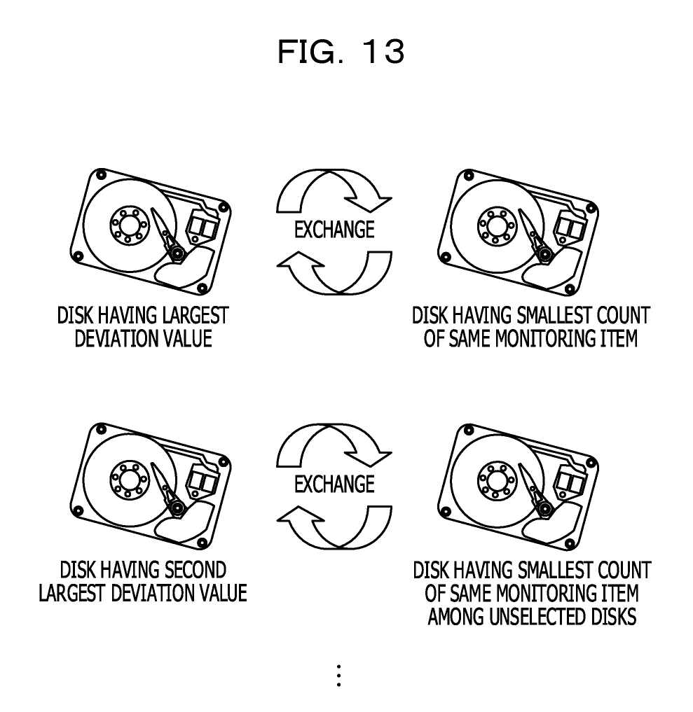

The replacement disk list generation unit 51d selects a disk having the largest deviation value and a disk having the smallest count of the monitoring item corresponding to the deviation value to associate the selected disks as a first pair of a replacement source disk and a replacement destination disk as illustrated in FIG. 13. Furthermore, as illustrated in FIG. 13, the replacement disk list generation unit 51d selects a disk having the n-th largest deviation value and a disk, from among unselected disks, having the smallest count of the monitoring item corresponding to the deviation value to associate the selected disks as an n-th pair of a replacement source disk and a replacement destination disk. Here, n is a natural number not less than 2 and not more than the number of elements of the replacement source disk list 12d.

Furthermore, when association of each of the first to n-th pairs is performed, the replacement disk list generation unit 51d selects a disk 21 which satisfies conditions (e1) to (e3) below as a replacement destination disk for a replacement source disk with reference to the replacement source disk list 12d and the replacement destination disk lists 12e.

(e1) A type of the replacement source disk and a type of the replacement destination disk are the same as each other.

(e2) Capacity of the replacement source disk and capacity of the replacement destination disk are the same as each other.

(e3) A difference between the mounting date of the replacement source disk and the mounting date of the replacement destination disk is within a predetermined period of time.

Here, the reason that the condition (e3) “a difference between the mounting date of the replacement source disk and the mounting date of the replacement destination disk is within a predetermined period of time” is employed will be described. The reason that the condition (e3) is employed is that data replacement performed between two disks having mounting dates far removed from each other may lead a result which does not match a basic principle to be realized by the storage device 1 of the first embodiment, that is, data replacement between a disk having a low use frequency and a disk having a high use frequency. When monitoring is performed for the monitoring items (a1) to (a4) according to the first embodiment, a driving state value (a count) of a disk which has been recently mounted seems to be small. However, a disk which has been recently mounted may have a considerably high use frequency in practice in some cases. Here, a first disk which has been recently mounted and which has a high use frequency and a second disk which has been mounted for quite a long time and which has a medium use frequency are taken as examples. In this case, since a driving state value of the first disk is small, the first disk is a candidate of a data replacement destination of the second disk which has a large driving state value. However, if data of the first disk and data of the second disk are exchanged with each other, the use frequency of the second disk is further increased. The situation occurs when the mounting date of the replacement source disk and the mounting date of the replacement destination disk are far removed from each other. Accordingly, in the first embodiment, the condition (e3) above is set so that data of disks which are mounted at substantially the same time is preferably exchanged. The predetermined period of time in the condition (e3) is three months, for example. The period of time “three month” is determined as a half of a half year which is assumed in the storage device 1 of the first embodiment as the shortest value of a process execution interval of the rearrangement control unit 50.

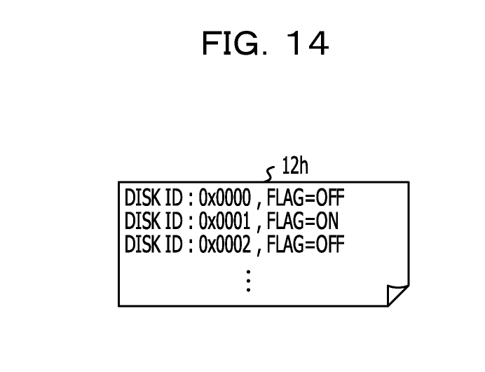

The replacement disk list generation unit 51d selects an unused disk 21 which satisfies conditions (f1) to (f3) below as the buffer disk used when data replacement is performed between the replacement source disk and the replacement destination disk which are associated with each other as described above. When the buffer disk is to be selected, a buffer disk flag list 12h, which will be described below with reference to FIG. 14, is used. In the first embodiment, use of the buffer disk enables temporary stop and restart of data copy in a data replacement process performed between the replacement source disk and the replacement destination disk and enables access for writing to the disks during the temporary stop.

(f1) No volume has been assigned to the disk.

(f2) The disk does not belong to any RAID group.

(f3) The disk has a type and capacity the same as those of the replacement source disk and the replacement destination disk.

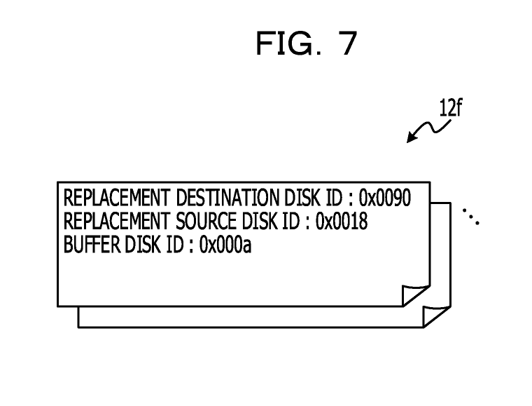

Then the replacement disk list generation unit 51d generates the replacement disk list 12f in which items (g1) to (g3) below are associated with one another as illustrated in FIG. 7. FIG. 7 is a diagram illustrating a concrete example of the replacement disk list 12f according to the first embodiment.

(g1) A disk ID of a replacement source disk

(g2) A disk ID of a replacement destination disk

(g3) A disk ID of a buffer disk

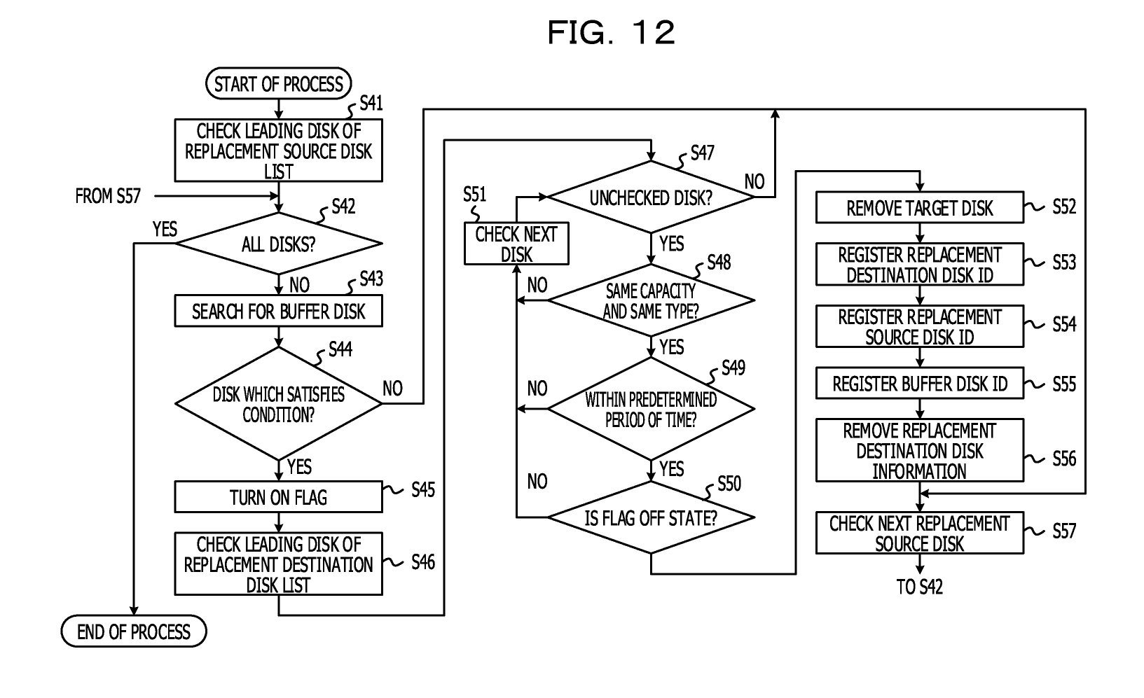

The number of elements of the replacement disk list 12f is the same as the number of elements of the replacement source disk list 12d, that is, the number of disks 21 which satisfy the predetermined data replacement condition. Furthermore, the replacement disk list generation unit 51d sorts the elements of the replacement disk list 12f in the same way as the sorting of the elements of the replacement source disk list 12d, that is, in descending order of deviation values of the item (c3). Operation of the replacement disk list generation unit 51d will be described later in detail with reference to FIGS. 12 to 14.

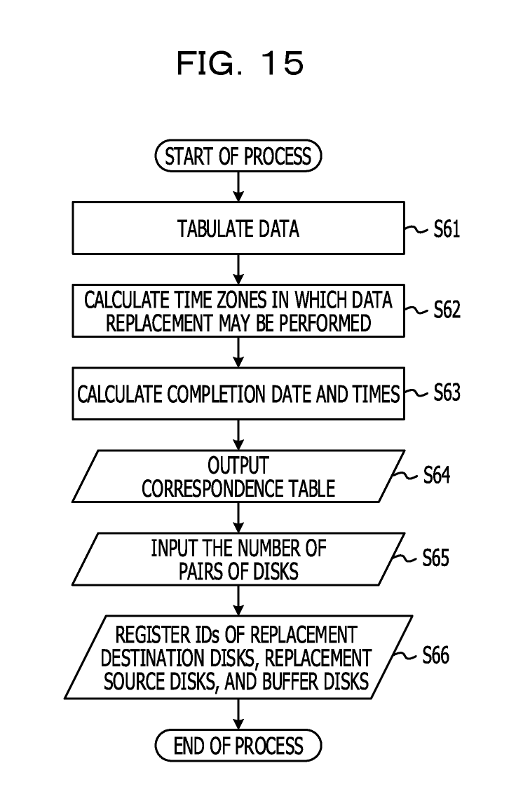

The data replacement disk determination unit 52 determines the number of pairs of disks which are to be actually subjected to the data replacement process on the basis of the replacement disk list 12f and the access time point table 12c. Specifically, the data replacement disk determination unit 52 analyzes access time points stored in the access time point table 12c, estimates periods of time required when data replacement is sequentially performed from the top of the pairs in the replacement disk list 12f, and estimates completion date and times of the data replacement process for individual numbers of pairs which are to be subjected to the data replacement process. Thereafter, the data replacement disk determination unit 52 notifies the user of the completion date and times of the data replacement process to be performed for individual numbers of pairs through the display unit 30 and prompts the user to determine and specify the number of pairs to be subjected to the data replacement process. The data replacement disk determination unit 52 receives a number specified by the user in response to the notification. The data replacement disk determination unit 52 generates a determination list (a fourth list) 12g in which the ID of the replacement source disk, the ID of the replacement destination disk, and the ID of the buffer disk are associated with one another on the basis of the number specified by the user. Therefore, the data replacement disk determination unit 52 has functions of an estimation unit 52a and a determination list generation unit 52b. Operation of the data replacement disk determination unit 52 (the estimation unit 52a and the determination list generation unit 52b) will be described later in detail with reference to FIGS. 15 and 16.

The estimation unit 52a estimates time zones available for execution of data replacement performed by the data replacement control unit 54, on the basis of access time points stored in the access time point table 12c. Specifically, the estimation unit 52a calculates periods of time in time zones in which the data replacement process may be performed for each day of the week with reference to the access time points included in the access time point table 12c so as to estimate time zones available for execution of data replacement.

Furthermore, the estimation unit 52a estimates completion date and times of cases where the data replacement control unit 54 performs data replacement on a first pair, first and second pairs, first to third pairs, . . . , and first to N-th pairs (N is a natural number) from the top of the replacement disk list 12f on the basis of the estimated execution available time zones and the replacement disk list 12f. Then the estimation unit 52a generates a correspondence table (which will be described later with reference to FIG. 16) in which the numbers of pairs, that is, 1 to N, are associated with the estimated completion date and times and notifies the user of the correspondence table. The correspondence table is displayed in the display unit 30, for example, as the notification for the user so as to prompt the user to determine the number of pairs to be subjected to the data replacement process. The user who refers to the correspondence table displayed in the display unit 30 specifies the number of pairs to be subjected to the data replacement process by operating the input operating unit 40.

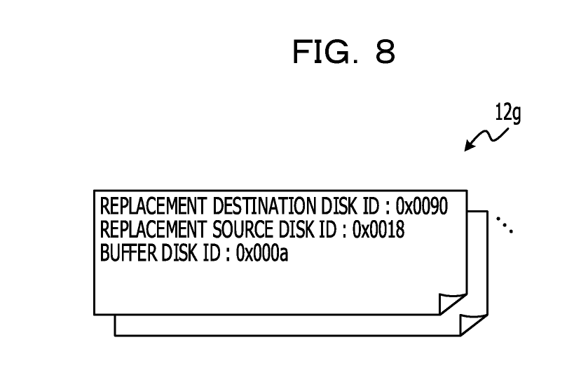

The determination list generation unit (a fourth list generation unit) 52b generates the determination list (the fourth list) 12g in which items (h1) to (h3) below are associated with one another as illustrated in FIG. 8, on the basis of the number of pairs specified by the user after the notification of the correspondence table. FIG. 8 is a diagram illustrating a concrete example of the determination list (the fourth list) 12g according to the first embodiment.

(h1) A disk ID of a replacement source disk to be subjected to data replacement performed by the data replacement control unit 54

(h2) A disk ID of a replacement destination disk to be subjected to data replacement performed by the data replacement control unit 54

(h3) A disk ID of a buffer disk

The number of elements of the determination list 12g corresponds to the number of the pairs specified by the user, and the determination list 12g is generated by extracting high-order elements of the replacement disk list 12f described above by the specified number of pairs. Accordingly, content of the elements of the determination list 12g and content of the elements of the replacement disk list 12f are the same as each other except for the number of elements. When the number of pairs specified by the user is the same as the number of elements of the replacement disk list 12f, the determination list 12g and the replacement disk list 12f are the same as each other.

Upon receiving a data replacement start instruction after the user specifies the number of pairs, the timing control unit 53 determines timings of start, temporary stop, restart, cancel, and the like of the data replacement process to be performed by the data replacement control unit 54, on the basis of the determination list 12g, and transmits instructions for start, temporary stop, restart, cancel, and so on to the data replacement control unit 54.

More specifically, first, the timing control unit 53 obtains time points when two disks to be subjected to replacement are accessed respectively, with reference to the access time points stored in the access time point table 12c. The timing control unit 53 analyzes and obtains time zones (execution available time zones) in which access to the two disks is not frequently performed or not performed, on the basis of the obtained access time points. When the obtained execution available time zones are entered, the timing control unit 53 transmits an instruction for starting or restarting data replacement to the data replacement control unit 54. On the other hand, when the obtained execution available time zones are escaped, the timing control unit 53 transmits an instruction for temporarily stopping data replacement to the data replacement control unit 54.

When one of the disks 21 subjected to data replacement is accessed for writing during data replacement performed by the data replacement control unit 54, the timing control unit 53 transmits an instruction for temporarily stopping the data replacement to the data replacement control unit 54 and transmits an instruction for restarting the data replacement to the data replacement control unit 54 after the access for writing is completed.

When a volume which is assigned to one of the disks 21 subjected to the data replacement is to be subjected to a copy session, the timing control unit 53 transmits an instruction for cancelling the data replacement to the data replacement control unit 54. When an error occurs in one of the disks 21 which temporarily stopped in the data replacement process or one of the disks 21 which subjected to the data replacement, the timing control unit 53 transmits an instruction for cancelling the data replacement to the data replacement control unit 54.

Moreover, the timing control unit 53 has a function of forbidding a setting of the economy mode described above in the execution available time zones or in a period of time in which data replacement is performed in the execution available time zones. The timing control unit 53 further has a function of inhibiting buffer disks registered in the determination list 12g to be incorporated in RAID groups and a function of inhibiting generation of volumes in the buffer disks.

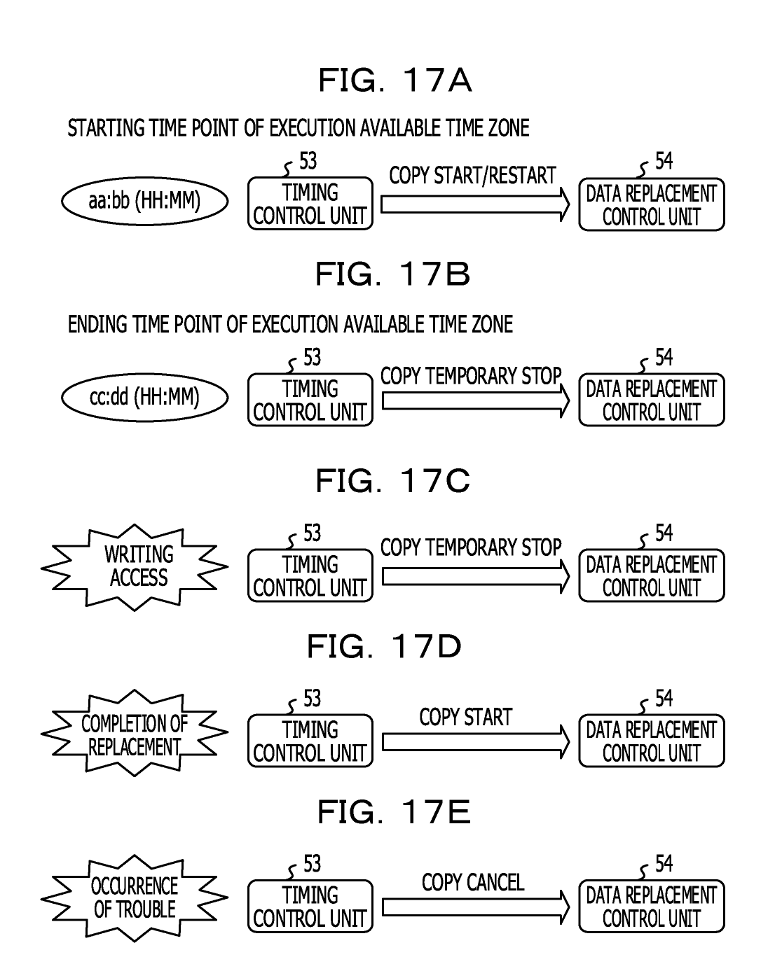

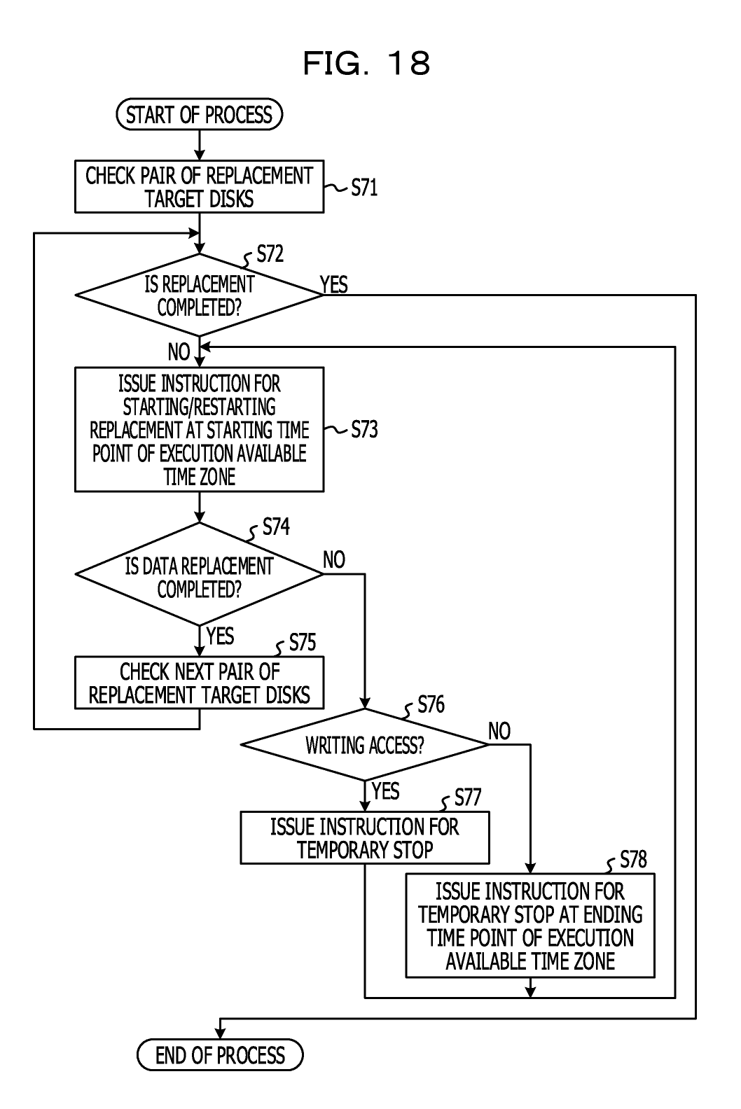

Operation of the timing control unit 53 will be described later in detail with reference to FIGS. 17 and 18.

The data replacement control unit (a replacement control unit) 54 performs data replacement between a replacement source disk and a replacement destination disk. The data replacement control unit 54 may execute start, temporary stop, restart, cancel, and the like in a data replacement (copy) process performed between the replacement source disk and the replacement destination disk, in accordance with instructions supplied from the timing control unit 53 described above. The data replacement control unit 54 has a function of enabling, during the temporary stop of the data replacement process, access to a volume assigned to a disk subjected to the replacement.

The data replacement control unit 54 sequentially reads the IDs of replacement source disks, the IDs of replacement destination disks, and the IDs of buffer disks from the top of the determination list 12g and performs data replacement between a replacement source disk and a replacement destination disk using a buffer disk on the basis of the read disk IDs.

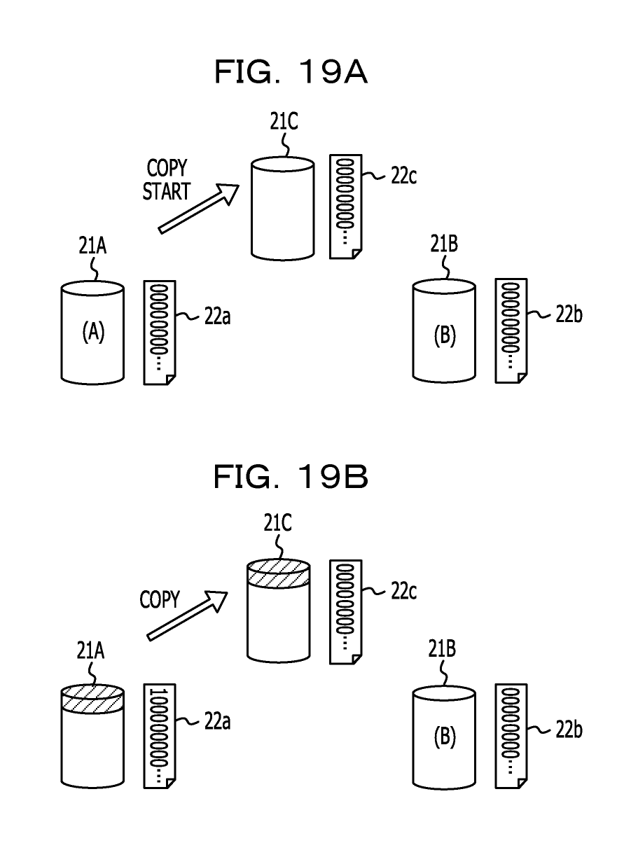

More specifically, the data replacement control unit 54 performs data replacement between a replacement source disk and a replacement destination disk using copy management bitmaps 22a to 22c in accordance with a procedure from (i1) to (i6) described below. Operation of the data replacement control unit 54 will be described later in detail with reference to FIGS. 19 to 22.

(i1) Data of the replacement source disk is copied in a buffer disk.

(i2) The buffer disk after the copy is exchanged with the replacement source disk.

(i3) Data of the replacement destination disk is copied in the replacement source disk.

(i4) The replacement source disk after the copy is exchanged with the replacement destination disk.

(i5) Data of the buffer disk is copied in the replacement destination disk.

(i6) The replacement destination disk after the copy is exchanged with the buffer disk.

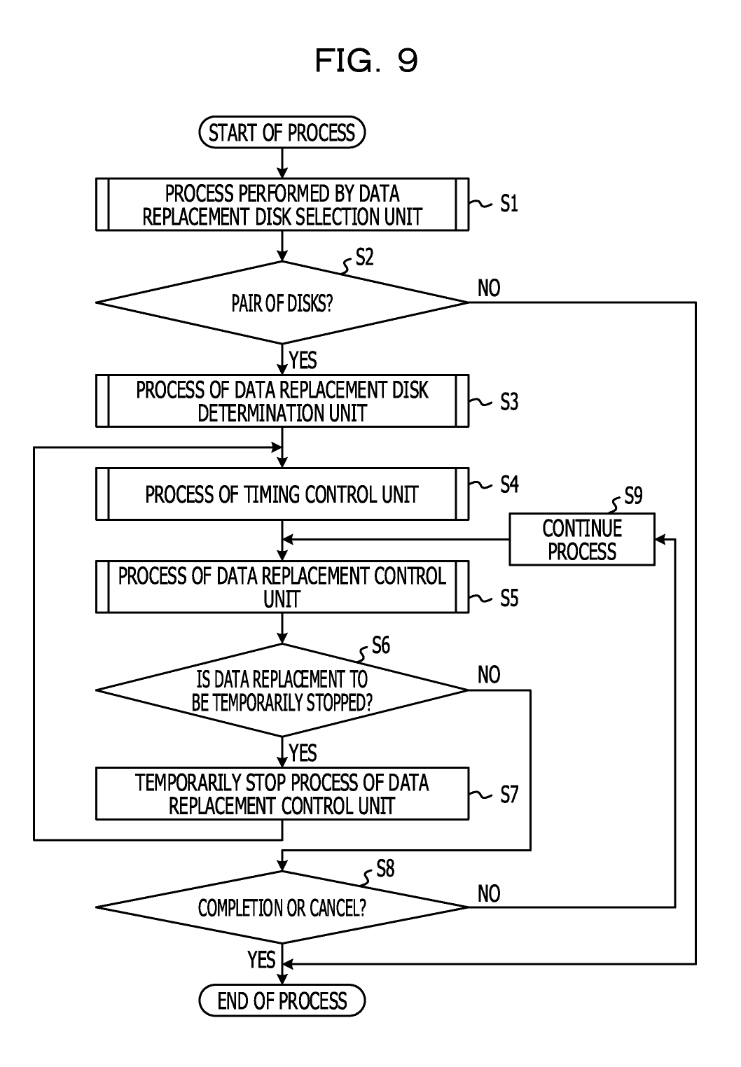

Next, operation of the storage device 1 (CM 10) configured as described above will be described with reference to FIGS. 9 to 22.

A disk array device (a RAID device) includes a large number of disks. As described above, it is highly likely that a disk having a high frequency of spin-up/spin-down of a driving motor, a high frequency of off/on operations of a driving motor, or a high frequency of off/on operations of power fails owing to wear of a platter, expansion/shrinkage caused by temperature change due to the state transition, or deterioration of a fluid dynamic bearing. Therefore, when use frequencies of disks included in a disk array device are not uniform, some disks may fail within a comparatively short period of time and some disks may not fail for a long period of time. In the first embodiment, use states of the disks 21 included in the storage device 1 are monitored and allocation of data is changed for each disk on the basis of a result of the monitoring. By this, since the use states of the disks 21 are uniformed, lives of the disks 21 are uniformed and availability of the storage device 1 is improved.

More specifically, in the first embodiment, driving state values (counts) of the monitoring items (a1) to (a4) described above of the disks 21 mounted on the storage device 1 are monitored. Then data replacement is performed on a disk basis so that the monitored driving state values do not become non-uniform among the disks 21 of the storage device 1. Although a type and capacity of a data replacement source disk are the same as those of a data replacement destination disk, the disks may belong to any RAID group and any configuration of a pool may be employed. The monitoring items (a1) to (a4) described above are generally referred to as failure factors of the disks 21. If a large count (driving state value) is detected in one of the items in a certain disk 21, a failure probability of the disk 21 may become high.

In the first embodiment, dates when the disks 21 are mounted on the storage device 1 are stored in the monitoring information lists 12b, the replacement source disk list 12d, and the replacement destination disk lists 12e, and when a difference between a mounting date of a replacement source disk and a mounting date of a replacement destination disk exceeds a predetermined period of time, execution of data replacement is avoided (refer to the condition (e3) above). The reason has been described hereinabove, and therefore, description thereof is omitted.

In the first embodiment, since data of the disks 21 is replaced on a disk basis, a large amount of data is copied. A copy process for data replacement between a replacement source disk and a replacement destination disk is performed in time zones in which access to the disks 21 is not frequently performed so that influence on work is as little as possible. It is assumed that a period of time used for completion of the data replacement is several days to several months. In the first embodiment, read/write access, particularly, write access may be executed during data replacement.

The data replacement process of the first embodiment described below is executed at a frequency of once every half a year or so, for example, and a start timing of the data replacement process is specified by the user. Before the data replacement process is started, date and times when the data replacement process is to be completed are calculated for individual numbers of pairs of disks, a correspondence table in which the numbers of pairs and the completion date and times are associated with each other is supplied to the user, and the user may select the number of pairs of disks to be subjected to the data replacement with reference to the correspondence table.

Next, operation of the rearrangement control unit 50 will be described in accordance with a flowchart (S1 to S9) illustrated in FIG. 9.

Before the rearrangement control unit 50 operates, the monitoring unit 17 monitors the driving state values of the monitoring items (a1) to (a4) for individual disks 21 and the driving state values are stored in the memory 12 as the monitoring table 12a. Similarly, the access time obtaining unit 18 obtains access time points of accesses from the host 2 to the disks 21, and the access time points are stored in the access time point table 12c.

The rearrangement control unit 50 starts the process at a timing specified by the user, and first, the data replacement disk selection unit 51 performs its process (S1). By this, the replacement disk list 12f in which IDs of a pair of disks 21 (a replacement source disk and a replacement destination disk) which are to be subjected to data replacement and an ID of a buffer disk are associated with one another is generated. The process in S1 will be described later with reference to FIGS. 10 to 14.

When no disk 21 satisfies the predetermined data replacement condition, that is, when no pair of disks 21 to be subjected to the data replacement exists (No in S2), the rearrangement control unit 50 terminates the process. On the other hand, when some disks 21 satisfy the predetermined data replacement condition, that is, when pairs of disks 21 to be subjected to the data replacement exist (YES in S2), the data replacement disk determination unit 52 of the rearrangement control unit 50 performs its process (S3). By this, on the basis of the number of pairs specified by the user, the determination list 12g in which the ID of the replacement source disk, the ID of the replacement destination disk, and the ID of the buffer disk are associated with one another is generated. The process in S3 will be described later with reference to FIGS. 15 and 16.

Thereafter, the timing control unit 53 included in the rearrangement control unit 50 executes its process (S4). Specifically, in the data replacement process performed on the basis of the determination list 12g by the data replacement control unit 54, timings of start, temporary stop, restart, and cancel are determined on the basis of the access time point table 12c, and the start, the temporary stop, the restart, and the cancel are instructed to the data replacement control unit 54 on the basis of the determined timings. The process in S4 will be described later with reference to FIGS. 17 and 18.

The data replacement control unit 54 included in the rearrangement control unit 50 executes its process in accordance with instructions issued by the timing control unit 53 (S5). By this, the ID of the replacement source disk, the ID of the replacement destination disk, and the ID of the buffer disk are sequentially read from the top of the determination list 12g and the data replacement is performed between the replacement source disk and the replacement destination disk using the buffer disk on the basis of the read disk IDs. The process in S5 will be described later with reference to FIGS. 19 to 22.

Upon receiving an instruction for temporarily stopping the data replacement from the timing control unit 53 during execution of the data replacement (YES in S6), the data replacement control unit 54 temporarily stops the data replacement process (S7) and the rearrangement control unit 50 returns to S4. On the other hand, when the instruction for temporarily stopping the data replacement is not supplied from the timing control unit 53 (NO in S6), the data replacement control unit 54 determines whether the data replacement process has been completed or whether an instruction for cancelling the data replacement is supplied from the timing control unit 53 (S8).

When the data replacement process is completed or when the instruction for cancelling the data replacement is supplied from the timing control unit 53 (YES in S8), the rearrangement control unit 50 terminates the process. On the other hand, when the data replacement process is not completed or when the instruction for cancelling the data replacement is not supplied from the timing control unit 53 (NO in S8), the rearrangement control unit 50 continues the process (S9) and the process returns to S5.

Next, operation of the data replacement disk selection unit 51 (the process in S1 of FIG. 9) will be described in accordance with a flowchart (S11 to S13) illustrated in FIG. 10.

The tabulating unit 51a of the data replacement disk selection unit 51 tabulates the driving state values of the monitoring items (a1) to (a4) included in the monitoring table 12a at a replacement start timing specified by the user so as to generate the monitoring information lists 12b for individual disks 21 as illustrated in FIG. 3 (S11). As illustrated in FIGS. 3 and 4, information on the items (b1) to (b8) is registered in the monitoring information lists 12b.

Thereafter, the data replacement disk selection unit 51 executes a process of generating the replacement source disk list 12d and the replacement destination disk lists 12e (S12). Specifically, the replacement source disk list generation unit 51b generates the replacement source disk list 12d and the replacement destination disk list generation unit 51c generates the replacement destination disk lists 12e. A process of generating a replacement source disk list and replacement destination disk lists will be described later with reference to FIG. 11.

As described above, the replacement source disk list 12d is a list having a number of elements corresponding to the number of disks 21 which satisfy the predetermined data replacement condition. Each of the elements has information on the items (c1) to (c6) described above and the elements are sorted in descending order of the deviation values of the item (c3). The replacement destination disk lists 12e are generated for individual monitoring items (types of driving state value) and each of the replacement destination disk lists 12e has a number of elements corresponding to the number of disks 21 mounted on the storage device 1. Each of the elements includes information on the items (d1) to (d5) and the elements are sorted in ascending order of the driving state values (counts) of the item (d2).

Thereafter, the data replacement disk selection unit 51 executes a process of generating the replacement disk list 12f (S13). Specifically, the replacement disk list generation unit 51d generates the replacement disk list 12f. The process of generating a replacement disk list performed in S13 will be described later with reference to FIGS. 12 to 14.

As described above, the replacement disk list 12f is a list having a number of elements corresponding to the number of disks 21 which satisfy the predetermined data replacement condition. Each of the elements of the replacement disk list 12f includes information on the items (g1) to (g3) described above and the elements are sorted in the same order as the replacement source disk list 12d, that is, in descending order of deviation values of the item (c3).

Next, operation of the replacement source disk list generation unit 51b and operation of the replacement destination disk list generation unit 51c (the process of generating a replacement source disk list and replacement destination disk lists in S12 of FIG. 10) will be described in accordance with a flowchart illustrated in FIGS. 11 (S21 to S36).

First, the data replacement disk selection unit 51 extracts a first monitoring item (S21) as a target. The replacement source disk list generation unit 51b calculates an average value μ and a standard deviation σ of driving state values (counts) corresponding to the target monitoring item with reference to the monitoring information lists 12b of all the disks 21 (S22 and S23). The replacement source disk list generation unit 51b checks one of the monitoring information lists 12b corresponding to a leading disk 21 (S24) and determines whether a detected count (a driving state value) x of the target monitoring item of the leading disk 21 satisfies the predetermined data replacement condition (Expression (1) described above) (S25).

When the detected count x does not satisfy Expression (1) (NO in S25), the data replacement disk selection unit 51 proceeds to S30. When the detected count x satisfies Expression (1) (YES in S25), the replacement source disk list generation unit 51b calculates a deviation value of the detected count x of the target monitoring item of the target disk 21 (S26).

The replacement source disk list generation unit 51b determines whether the target disk 21 has been registered in the replacement source disk list 12d with one of the monitoring items which is different from the target monitoring item as a replacement factor (the item (c2)) (S27). When the target disk 21 has not been registered in the replacement source disk list 12d with another monitoring item as a replacement factor (NO in S27), the replacement source disk list generation unit 51b proceeds to S29.

When the target disk 21 has been registered in the replacement source disk list 12d with another monitoring item as a replacement factor (YES in S27), the replacement source disk list generation unit 51b determines whether the deviation value calculated in S26 (a deviation value of the target monitoring item) is larger than a deviation value (the item (c3)) of the other monitoring item registered in the replacement source disk list 12d (S28). When the deviation value calculated in S26 is not larger than the deviation value of the other monitoring item which has been registered (NO in S28), the data replacement disk selection unit 51 proceeds to S30.

When the deviation value calculated in S26 is larger than the deviation value of the other monitoring item which has been registered (YES in S28), the replacement source disk list generation unit 51b registers information on the target disk 21 (the items (c1) to (c6)) in the replacement source disk list 12d. Here, the replacement source disk list generation unit 51b registers the target monitoring item in the replacement source disk list 12d as a replacement factor (the item (c2)) (S29).

Then the replacement destination disk list generation unit 51c registers information on the target disk 21 (the items (d1) to (d5)) in the replacement destination disk list 12e corresponding to the target monitoring item (S30).

Thereafter, the data replacement disk selection unit 51 (the replacement source disk list generation unit 51b) determines whether the monitoring information lists 12b of all the disks 21 have been checked (S31). When at least one of the monitoring information lists 12b of all the disks 21 has not been checked (NO in S31), the data replacement disk selection unit 51 checks the monitoring information list 12b of a next disk 21 (S32), extracts the next disk 21 as a target disk, and performs the process from S25 to S31 again.

When the monitoring information lists 12b of all the disks 21 have been checked (YES in S31), the replacement destination disk list generation unit 51c sorts the elements of the replacement destination disk list 12e corresponding to the target monitoring item in ascending order of the driving state values (counts) of the target item (the item (d2)) (S33). By this, using the replacement destination disk list 12e, the disks 21 which are mounted on the storage device 1 are determined as replacement destination disks in ascending order of the driving state values.

Furthermore, the data replacement disk selection unit 51 determines whether all the monitoring items have been extracted and checked (S34). When at least one of the monitoring items has not been checked (NO in S34), the data replacement disk selection unit 51 checks a next monitoring item (S35), the next monitoring item is extracted as a target monitoring item, and the process from S22 to S34 is performed again.

When all the monitoring items have been checked (YES in S34), the replacement source disk list generation unit 51b sorts the elements of the replacement source disk list 12d in descending order of the deviation values (the item (c3)) (S36). By this, using the replacement source disk list 12d, the disks 21 which satisfy the predetermined data replacement condition are determined as replacement source disks in descending order of the deviation values.

Next, operation (the process of generating replacement disk list in S13 of FIG. 10) of the replacement disk list generation unit (a third list generation unit) 51d will be described in accordance with a flowchart illustrated in FIGS. 12 (S41 to S57) with reference to FIGS. 13 and 14. FIG. 13 is a diagram illustrating the operation of the replacement disk list generation unit 51d and FIG. 14 is a diagram illustrating a concrete example of the buffer disk flag list 12h according to the first embodiment.

Here, a procedure of generation of the replacement disk list 12f on the basis of the replacement source disk list 12d generated by the replacement source disk list generation unit 51b and the replacement destination disk lists 12e generated for respective monitoring items by the replacement destination disk list generation unit 51c will be described. Only one replacement disk list 12f is generated for the storage device 1 and the number of elements of the replacement disk list 12f is the same as the number of elements of the replacement source disk list 12d, that is, the number of disks 21 which satisfy the predetermined data replacement condition.

In the first embodiment, a buffer disk is selected to be used when the data replacement is performed between a replacement source disk and a replacement destination disk. The buffer disks are excluded from candidates for the replacement destination disks. This is because, if the buffer disks are not excluded from candidates for the replacement destination disks, a replacement destination disk (a disk after replacement) to which data of the replacement source disk has been copied may be used as a buffer disk and the data is rewritten. Note that, although disks selected as the buffer disks are excluded from candidates of the replacement destination disks, the disks may be repeatedly selected as buffer disks.

Therefore, in the first embodiment, the buffer disk flag list 12h illustrated in FIG. 14 is stored in the memory 12 independently from the replacement destination disk lists 12e. In an initial sate, the number of elements included in the buffer disk flag list 12h corresponds to the number of all the disks included in the storage device 1. In the initial sate of the buffer disk flag list 12h, all of the flags corresponding to the respective disks 21 are off states. A flag of one of the disks 21 which is once selected as the buffer disk is changed from the off state to an on state. As for the disks 21 which satisfy the conditions (the items (e1) to (e3)) for a replacement destination disk, flags of the disks 21 are referred to in the buffer disk flag list 12h. When a flag of one of the disks 21 is in an on state, the next replacement destination disk is checked (refer to NO in S50 and S51 in FIG. 12 described later). On the other hand, when the flag of the disk 21 is in an off state in the buffer disk flag list 12h, information (an element) of the disk 21 is removed from the buffer disk flag list 12h (refer to a YES in S50 and S52 in FIG. 12 described later). The process described above is performed so that a requirement in which buffer disks are excluded from candidates for the replacement destination disks is satisfied.

The replacement disk list generation unit 51d checks a leading replacement source disk of the replacement source disk list 12d (S41) and determines whether all the disks 21 included in the replacement source disk list 12d have been checked (S42). When all the disks 21 included in the replacement source disk list 12d have been checked (YES in S42), the replacement disk list generation unit 51d terminates the process. On the other hand, when at least one of the disks 21 of the replacement source disk list 12d has not been checked (NO in S42), the replacement disk list generation unit 51d executes a process below (S43 to S57).

The replacement disk list generation unit 51d searches the storage device 1 for buffer disks among the disks 21 included in the buffer disk flag list 12h (S43). Then the replacement disk list generation unit 51d determines whether a disk which satisfies the conditions (the items (f1) to (f3)) for a buffer disk is included in the obtained disks (S44). When no disk satisfies the conditions for a buffer disk (NO in S44), the replacement disk list generation unit 51d proceeds to S57.

When a disk 21 included in the buffer disk flag list 12h satisfies the conditions for a buffer disk (YES in S44), the replacement disk list generation unit 51d selects the disk 21 as a buffer disk and sets a flag corresponding to the selected disk 21 to an on state (S45).

Thereafter, the replacement disk list generation unit 51d checks a leading replacement destination disk of the replacement destination disk list 12e corresponding to the replacement factor (the item (c2)) of the target replacement source disk (S46). Then the replacement disk list generation unit 51d first determines whether an unchecked disk 21 is included in the replacement destination disk list 12e (S47). When no unchecked disk 21 is included in the replacement destination disk list 12e (NO in S47), the replacement disk list generation unit 51d proceeds to S57.

When an unchecked disk 21 is included in the replacement destination disk list 12e (YES in S47), the replacement disk list generation unit 51d determines whether capacity and a type of the target replacement destination disk are the same as those of the target replacement source disk, that is, whether the conditions (e1) and (e2) are satisfied (S48). When the conditions (e1) and (e2) are not satisfied (NO in S48), the replacement disk list generation unit 51d checks the next replacement destination disk included in the replacement destination disk list 12e corresponding to the replacement factor (the item (c2)) of the target replacement source disk (S51) and the process returns to S47.

When the conditions (e1) and (e2) are satisfied (YES in S48), the replacement disk list generation unit 51d determines whether a difference between a mounting date of the target replacement source disk and a mounting date of the target replacement destination disk is within a predetermined period of time, that is, whether the condition (e3) is satisfied (S49). When the condition (e3) is not satisfied (NO in S49), the replacement disk list generation unit 51d checks the next replacement destination disk included in the replacement destination disk list 12e corresponding to the replacement factor (the item (c2)) of the target replacement source disk (S51) and the process returns to S47.

When the condition (e3) is satisfied (YES in S49), the replacement disk list generation unit 51d determines whether a flag of the target replacement destination disk is in an off state with reference to the buffer disk flag list 12h (S50). When the flag of the target replacement destination disk is in an on state (NO in S50), the replacement disk list generation unit 51d checks the next replacement destination disk included in the replacement destination disk list 12e corresponding to the replacement factor (the item (c2)) of the target replacement source disk (S51) and the process returns to S47.

When the flag of the target replacement destination disk is in an off state (YES in S50), the replacement disk list generation unit 51d removes information (an element) of the target disk 21 from the buffer disk flag list 12h (S52). Then the replacement disk list generation unit 51d registers an ID of the replacement destination disk (the item (g2)), an ID of the target replacement source disk (the item (g1)), and an ID of the buffer disk (the item (g3)) in the replacement disk list 12f (S53 to S55).

Thereafter, the replacement disk list generation unit 51d removes information on the currently registered replacement destination disk from the replacement destination disk lists 12e of all the monitoring items (S56). The replacement disk list generation unit 51d checks the next replacement source disk included in the replacement source disk list 12d (S57), and the process from S42 to S57 is performed again on the next replacement source disk.

By this, in the first embodiment, as illustrated in FIG. 13, a disk having the largest deviation value is associated with a disk having the smallest count of a monitoring item corresponding to the deviation value as a first pair of a replacement source disk and a replacement destination disk. Furthermore, as illustrated in FIG. 13, a disk having the n-th largest deviation value is associated with a disk, which is selected from among unselected disks, having the smallest count of a monitoring item corresponding to the deviation value as an n-th pair of a replacement source disk and a replacement destination disk. In this case, one of the disks 21 which satisfies the conditions (e1) to (e3) is selected as the replacement destination disk for the replacement source disk. Moreover, an unused one of the disks 21 which satisfies the conditions (f1) to (f3) is selected as a buffer disk. Then the replacement disk list 12f in which an ID (the item (g1)) of the replacement source disk, an ID (the item (g2)) of the replacement destination disk, and an ID (the item (g3)) of the buffer disk are associated with one another is generated. The elements of the replacement disk list 12f are sorted in the same order as the replacement source disk list 12d, that is, in descending order of deviation values of the item (c3).

Next, operation (the process in S3 of FIG. 9) of the data replacement disk determination unit 52 (the estimation unit 52a and the determination list generation unit 52b) will be described in accordance with a flowchart (S61 to S66) illustrated in FIG. 15 with reference to FIG. 16. FIG. 16 is a diagram illustrating an example of the correspondence table generated by the estimation unit 52a.

The estimation unit 52a performs tabulation with reference to the access time points stored in the access time point table 12c (S61), analyzes a periods of time when less access is performed for individual days of the week, and calculates time zones in which data replacement may be executed (S62). Specifically, the estimation unit 52a calculates periods of time in time zones in which the data replacement process may be performed so as to estimate data replacement execution available time zones.

Furthermore, the estimation unit 52a estimates completion date and times in a case where the data replacement control unit 54 performs data replacement on a first pair, first and second pairs, first to third pairs, . . . , and first to N-th pairs from the top of the replacement disk list 12f on the basis of the estimated execution available time zones and the replacement disk list 12f (S63). Then the estimation unit 52a generates the correspondence table (refer to FIG. 16) in which the numbers of pairs, that is, 1 to N, are associated with the estimated completion date and times and notifies the user of the correspondence table (S64). The correspondence table is displayed in the display unit 30 as the notification for the user so as to prompt the user to determine the number of pairs to be subjected to the data replacement process. The user who refers to the correspondence table displayed in the display unit 30 specifies the number of pairs to be subjected to the data replacement process by operating the input operating unit 40 (S65).

Thereafter, the determination list generation unit 52b registers the items (h1) to (h3) associated with one another in the determination list 12g on the basis of the number of pairs specified by the user in response to the notification of the correspondence table (S66). The determination list 12g thus generated includes pairs of IDs of a replacement source disk and a replacement destination disk which are to be subjected to data replacement performed by the data replacement control unit 54 in practice and IDs of buffer disks in associated with the respective pairs as described above and the number of elements corresponds to the number of pairs specified by the user.

Next, operation (the process in S4 of FIG. 9) of the timing control unit 53 will be described in accordance with a flowchart (S71 to S78) illustrated in FIG. 18 with reference to FIGS. 17A to 17E. FIGS. 17A to 17E are diagrams illustrating operation of the timing control unit 53.

First, upon receiving a data replacement start instruction after the user specifies the number of pairs, the timing control unit 53 obtains, with reference to the access time points stored in the access time point table 12c, access time points when two disks which are targets of replacement have been accessed. Furthermore, on the basis of the obtained access time points, the timing control unit 53 analyzes and obtains time zones (execution available time zones) in which access to the two disks are not frequently performed or not performed.

Then the timing control unit 53 checks a first pair of replacement target disks included in the determination list 12g or a pair of disks which has been temporarily stopped after replacement is started (S71). Thereafter, the timing control unit 53 determines whether all pairs of replacement target disks included in the determination list 12g have been subjected to a replacement process (S72). When the replacement process has been performed on all the pairs of replacement target disks (YES in S72), the timing control unit 53 terminates the process. On the other hand, when at least one of the pairs of replacement target disks has not been subjected to the replacement process (NO in S72), the timing control unit 53 instructs the data replacement control unit 54 to start or restart data replacement when an execution available time zone is entered as illustrated in FIG. 17A (S73).

Thereafter, the timing control unit 53 determines whether data replacement performed on the pair of replacement target disks which is currently checked is completed (S74). When the data replacement is completed (YES in S74), the timing control unit 53 checks a next pair of replacement target disks in the determination list 12g (S75). After returning to S72, as illustrated in FIG. 17D, the timing control unit 53 instructs the data replacement control unit 54 to start performing data replacement on the next pair of replacement target disks (No in S72 to S73).

When the data replacement has not been completed (NO in S74), the timing control unit 53 determines whether one of the replacement target disks 21 is accessed for writing during the data replacement performed by the data replacement control unit 54 (S76). When one of the disks 21 is accessed for writing during the data replacement (YES in S76), the timing control unit 53 instructs the data replacement control unit 54 to temporarily stop the data replacement as illustrated in FIG. 17C (S77). Thereafter, the timing control unit 53 returns to S73, and after the writing access is completed, the timing control unit 53 instructs the data replacement control unit 54 to restart the data replacement when an execution available time zone is entered.

When no disk 21 is accessed for writing during the data replacement (NO in S76), as illustrated in FIG. 17B, the timing control unit 53 instructs the data replacement control unit 54 to temporarily stop the data replacement when the execution available time zone is escaped (at a determined time point, that is, an ending time point of the execution available time zone) (S78). Thereafter, the timing control unit 53 returns to S73.

In the flowchart illustrated in FIG. 18, a case where an event which forces to cancel the data replacement does not occur is described. However, when the following event occurs, the timing control unit 53 instructs the data replacement control unit 54 to cancel the data replacement as illustrated in FIG. 17E and the next pair of disks is processed. Examples of the event which forces to cancel the data replacement include a case where a copy session is set to a volume assigned to a disk 21 which is being subjected to the data replacement, a case where some sort of trouble occurs in a disk 21 which is temporarily stopped during the data replacement or a disk 21 which is being subjected to the data replacement, and a case where a buffer disk becomes unavailable.

The data replacement control unit 54 performs data replacement between a replacement source disk and a replacement destination disk using a buffer disk in accordance with an instruction issued by the timing control unit 53. In this case, the data replacement control unit 54 sequentially reads IDs of a replacement source disk, a replacement destination disk, and a buffer disk from the top of the determination list 12g. Then the data replacement control unit 54 performs data replacement between the replacement source disk and the replacement destination disk using the buffer disk in the procedure from (i1) to (i6) on the basis of the read disk IDs.

Next, operation of the data replacement control unit 54 of the first embodiment will be described in detail with reference to FIGS. 19A and 19B, FIGS. 20A to 20C, FIGS. 21A to 21C, and FIGS. 22A to 22C. FIGS. 19A and 19B, FIGS. 20A to 20C, FIGS. 21A to 21C, and FIGS. 22A to 22C are diagrams illustrating detailed operation of the data replacement control unit 54 of the first embodiment.

In the first embodiment, as illustrated in FIGS. 19A and 19B, FIGS. 20A to 20C, FIGS. 21A to 21C, and FIGS. 22A to 22C, a case where data replacement is performed between a disk (a replacement source disk) 21A and a disk (a replacement destination disk) 21B using a buffer disk 21C will be described. Furthermore, the data replacement control unit 54 includes the copy management bitmaps 22a to 22c for managing progress of the data replacement (copy).

The copy management bitmaps 22a to 22c individually include a plurality of bits corresponding to a plurality of data blocks of the disks 21A to 21C, respectively. As illustrated in FIG. 19A, “0” (an off state) is set to all bits when the data replacement is started (before copy is executed). Then, every time copy of a data block is completed, “1” (an on state) is set to one of the bits corresponding to the data block for which the copy is completed.

Furthermore, “0” is set to a bit of the bitmaps 22a to 22c corresponding to a data block which is accessed for writing during temporary stop. The copy is restarted from a data block corresponding to a bit of the bitmaps 22a to 22c to which “0” is set. Since it is determined that the copy of a data block corresponding to a bit of the bitmaps 22a to 22c to which “1” is set is completed, the copy is not executed again. Using the copy management bitmaps 22a to 22c, a data block which has been rewritten by the access for writing performed during the temporary stop is recognized and a data block to be subjected to copy when the copy is restarted may be recognized.

Hereinafter, a flow of the data replacement process performed on the disks 21A and 21B using the buffer disk 21C and the copy management bitmaps 22a to 22c will be described.

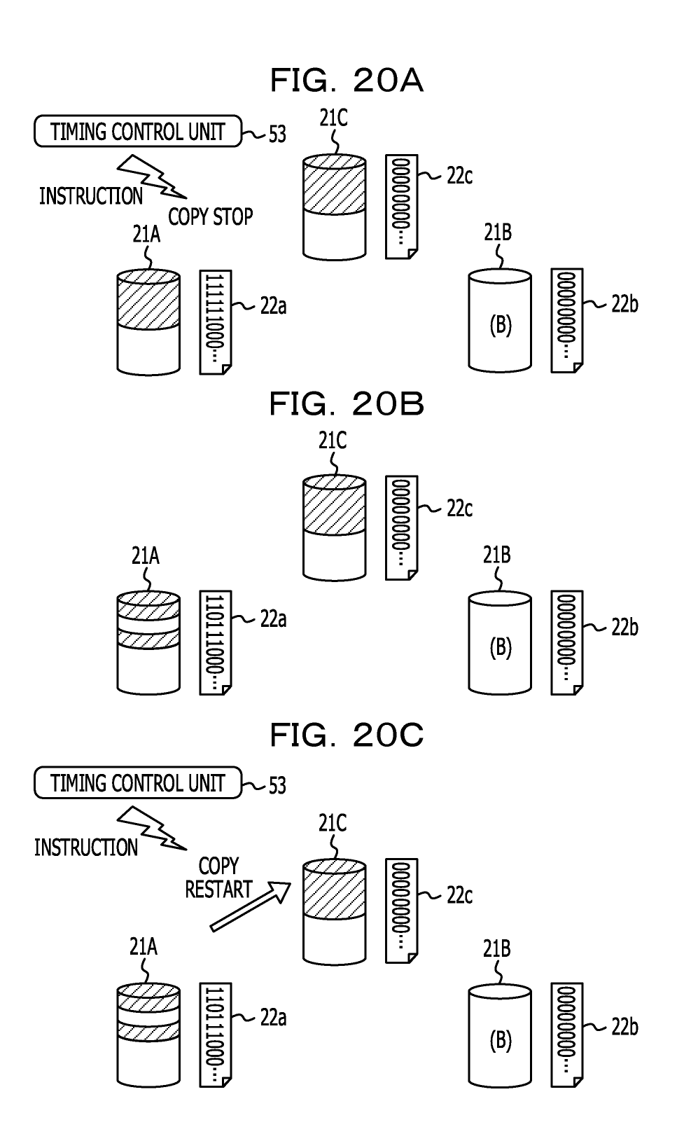

First, the data replacement control unit 54 starts a process of copying data (A) of the replacement source disk 21A to the buffer disk 21C for each data block as illustrated in FIG. 19A. The data replacement control unit 54 sets “1” to bits in the bitmap 22a corresponding to data blocks which have been copied as illustrated in FIG. 19B. The data replacement control unit 54 repeatedly performs the copy process for individual data blocks until the timing control unit 53 issues an instruction for temporarily stopping the copy as illustrated in FIG. 20A.

When a data block which has been copied is accessed for writing during the temporary stop, the data replacement control unit 54 sets “0” to the bit of the bitmap 22a corresponding to the data block which has been accessed for writing as illustrated in FIG. 20B. Thereafter, upon receiving an instruction for restarting the copy from the timing control unit 53, the data replacement control unit 54 restarts the copy of the data block corresponding to the bit of the bitmap 22a to which “0” has been set as illustrated in FIG. 20C.

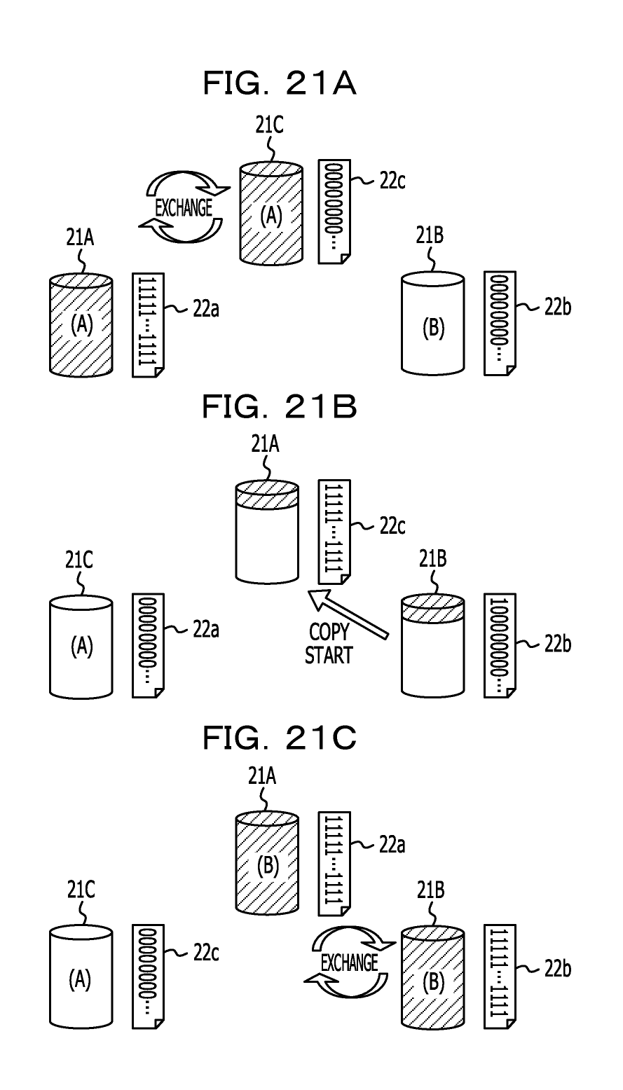

When copy of all data (A) of the replacement source disk 21A to the buffer disk 21C is completed, the data of the buffer disk 21C is equivalent to the data of the replacement source disk 21A. In this state, the data replacement control unit 54 causes the buffer disk 21C to be incorporated in a RAID group of the replacement source disk 21A instead of the replacement source disk 21A as illustrated in FIG. 21A. In this stage, the data replacement control unit 54 completes the procedure from (i1) to (i2) described above.

Thereafter, the data replacement control unit 54 starts a process of copying data (B) of the replacement destination disk 21B to the replacement source disk 21A for each data block and sets “1” to bits of the bitmap 22b corresponding to data blocks which have been copied as illustrated in FIG. 21B. This copy process is repeatedly performed. When copy of all the data (B) of the replacement destination disk 21B to the replacement source disk 21A is completed, the data of the replacement destination disk 21B is equivalent to the data of the replacement source disk 21A. In this state, the data replacement control unit 54 causes the replacement source disk 21A to be incorporated in a RAID group of the replacement destination disk 21B instead of the replacement destination disk 21B as illustrated in FIG. 21C. In this stage, the data replacement control unit 54 completes the procedure from (i3) to (i4) described above.

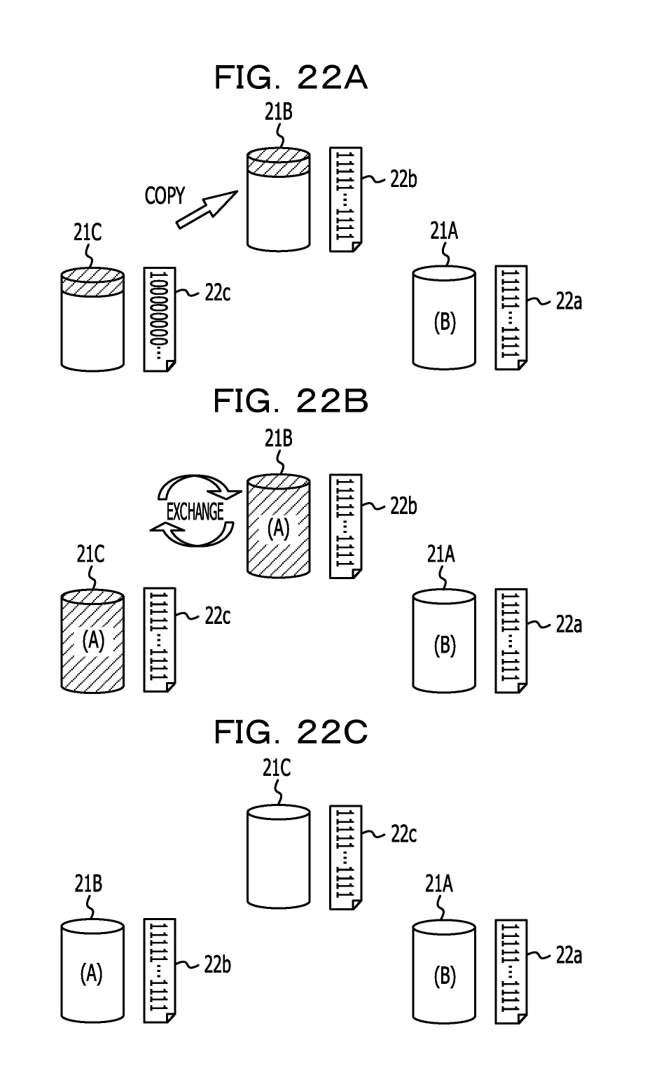

Thereafter, the data replacement control unit 54 starts a process of copying data of the buffer disk 21C which has been incorporated into the RAID group instead of the replacement source disk 21A to the replacement destination disk 21B for each data block and sets “1” to bits of the bitmap 22c corresponding to data blocks which have been copied as illustrated in FIG. 22A. This copy process is repeatedly performed. When copy of all the data (A) of the buffer disk 21C to the replacement destination disk 21B is completed, the data of the replacement destination disk 21B is equivalent to the data of the buffer disk 21C. In this state, the data replacement control unit 54 causes the replacement destination disk 21B to be incorporated in a RAID group instead of the buffer disk 21C as illustrated in FIG. 22B. In this stage, the data replacement control unit 54 completes the procedure from (i5) to (i6), and the data replacement performed between the replacement source disk 21A and the replacement destination disk 21B is completed as illustrated in FIG. 22C.

When a trouble occurs in at least one of the disks 21A to 21C during the data replacement, for example, the timing control unit 53 issues an instruction for cancelling the data replacement process to the data replacement control unit 54. In this case, if the instruction is issued before the buffer disk 21C is incorporated in the RAID group (before the process of FIG. 21A), a state of the data may return to a state before the data replacement process is performed. However, if the data replacement process is cancelled after the buffer disk 21C is incorporated in the RAID group, the process may not be completed in a state desired by the user. In this case, the data replacement control unit 54 outputs a warning message representing that the buffer disk 21C has been incorporated in the RAID group to a user interface (a UI; the input operating unit 40, for example) and prompts the user to perform RAID migration or disk active maintenance where appropriate. In the first embodiment, a process of forcedly returning a state of data to a state before a data replacement process is not performed.

According to the storage device 1 and the storage control device (CM) 10 of the first embodiment, use states of the disks 21 included in the storage device 1 are monitored and allocation of data is changed based on a result of the monitoring on a disk basis. By this, failure intervals of the individual disks 21 included in the storage device 1, that is, periods of time from when the individual disks 21 are mounted to when the disks 21 fail may be uniformed to a certain extent. Accordingly, lives of the disks 21 are uniformed and availability of the storage device 1 is considerably improved. Furthermore, in the first embodiment, since monitoring and data replacement are performed on a disk basis, failure probabilities of the disks 21 are uniformed and the failure intervals of the disks 21 are uniformed even when the economy mode is on.

In particular, in the first embodiment, the following advantages (j1) to (j3) may be obtained since the failure intervals of the disks 21 are uniformed.

(j1) Maintenance of the storage device 1 may be easily planned. Specifically, since timings when the failure probabilities of the disks 21 mounted on the storage device 1 become high are substantially the same as one another, maintenance of the disks 21 included in the storage device 1 may be scheduled. Consequently, a frequency of visit of a job site by customer engineers (CEs) or system administrators at a time of disk failure is reduced and a frequency of a case where the CEs or the system administrators go to work for replacement of disks late at night is reduced, and accordingly, maintenance cost may be reduced.

(j2) The disks 21 do not unexpectedly fail. Specifically, since replacement of the disks 21 may be performed as scheduled, probabilities of sudden failures of the disks 21 at an important timing become low. For example, a case where two of the disks 21 go down in a RAID-5 may be avoided.

(j3) A case where only the disks 21 which belong to a specific RAID group or a specific pool frequently fail may be avoided. That is, since the failure intervals of the disks 21 are uniformed in the storage device 1, a case where only the disks 21 included in a RAID group or a pool to which a volume having a high use frequency is assigned frequently fail may be avoided. By this, a probability of occurrence of a case where a volume having a high use frequency is not allowed to be accessed and a probability of occurrence of a case where a disk failure which leads to data loss of the volume occurs are reduced.

### Other Embodiments

Although the first embodiment of the present technique has been described hereinabove, embodiments are not limited to the first embodiment, and various modifications and alternations may be made within the scope of the present technique.

Although the case where the storage drive is an HDD has been described in the first embodiment, embodiments are not limited to this. For example, the present technique is similarly applicable to a solid state drive (SSD), and in this case, operation and effects the same as those of the first embodiment may be obtained. Although the number of times the power or the driving motors are turned off/on and the number of times the driving motors are subjected to spin-up/spin-down do not affect a life of the SSD, an access frequency (access counts) may directly affect the life of the SSD. Accordingly, if an access frequency is employed as a monitoring item (a driving state value) when the present technique is to be applied to the SSD, the present technique may be similarly applied to the SSD, and operation and effects the same as those of the first embodiment may be obtained.

Furthermore, all or some of functions of the I/O control unit 15, the system control unit 16, the monitoring unit 17, the access time obtaining unit 18, and the rearrangement control unit 50 (the data replacement disk selection unit 51, the tabulating unit 51a, the replacement source disk list generation unit 51b, the replacement destination disk list generation unit 51c, the data replacement disk determination unit 52, the estimation unit 52a, the determination list generation unit 52b, the timing control unit 53, and the data replacement control unit 54) are realized when a computer (including a CPU, an information processing apparatus, and various terminals) executes predetermined application programs.

The application programs are supplied by being recorded in a computer readable recording medium such as a flexible disk, a compact disc (CD) including a CD-ROM, a CD-R, and a CD-RW, a digital versatile disk (DVD) including a DVD-ROM, a DVD-RAM, a DVD-R, a DVD-RW, DVD+R, and DVD+RW, and a blu-ray disc. In this case, the computer reads programs from the recording medium, transfers the programs to an internal storage device or an external storage device, and stores the programs in the internal storage device or the external storage device to use the programs.

Here, the computer is a concept including hardware and an OS and corresponds to the hardware operating under control of the OS. When an application program solely operates the hardware without the OS, the hardware itself corresponds to the computer. The hardware at least includes a microprocessor such as a CPU and a unit for reading computer programs recorded in a recording medium. The application programs includes program codes which cause the computer described above to realize the functions of the I/O control unit 15, the system control unit 16, the monitoring unit 17, the access time obtaining unit 18, and the rearrangement control unit 50. Furthermore, some of the functions may be realized by the OS instead of the application programs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the first embodiment of the present invention has been described in detail, it should be understood that the various changes, substitutions, and alterations could be made hereto without departing from the spirit and scope of the invention.

What is claimed is:

1. A storage control device, comprising:
a processor configured to
monitor driving states of each of a plurality of storage drives included in a storage device, and
rearrange data stored in the storage drives so that the driving states of the storage drives are uniformed.

2. The storage control device according to claim 1, wherein
the processor is configured to
monitor, as the driving states, one or more types of driving state values correlating with deterioration of the storage drives.

3. The storage control device according to claim 2, wherein
the processor is configured to
monitor, as the driving state values, at least one of
a number of times power of each storage drive is turned off/on,
a number of times a driving motor of each storage drive is turned off/on,
a number of times spin-up or spin-down is performed by the driving motor, and
a number of times each storage drive is accessed.

4. The storage control device according to claim 2, wherein
the processor is configured to
select, based on the driving state values, two storage drives which have driving states different from each other, and
replace data stored in the selected two storage drives with each other.

5. The storage control device according to claim 2, wherein
the processor is configured to
calculate a deviation value of the driving state values of each storage drive for each type of the driving state values,
generate a first list having first elements each including first identification information (ID) for identifying a first storage drive, a first deviation value, and type information in association with one another, the first deviation value being largest among deviation values calculated for the first storage drive, the type information representing a type of a first driving state value corresponding to the first deviation value, the first elements being sorted in descending order of the first deviation value,
generate, for each type of the driving state values, a second list having second elements each including second ID for identifying a second storage drive and a second driving state value of the second storage drive in association with each other, the second elements being sorted in ascending order of the second driving state value,
generate, based on the first list and the second lists, a third list having third elements each including source ID, destination ID, and buffer ID in association with one another, the source ID identifying a source storage drive, the destination ID identifying a destination storage drive, the buffer ID identifying a buffer storage drive used for replacement of data between the source storage drive and the destination storage drive, and
perform the replacement in an order of the third elements, based on the source ID, the destination ID, and the buffer ID included in each third element.

6. The storage control device according to claim 5, wherein
the processor is configured to
omit storage drives having first deviation values less than a predetermined value in generating the first list.

7. The storage control device according to claim 5, wherein
the processor is configured to
further include in each first element, in association with the first ID, a mounting date and time, a storage type, and a capacity of the first storage drive,
further include in each second element, in association with the second ID, a mounting date and time, a storage type, and a capacity of the second storage drive, and
generate the third list such that a source storage drive and a destination storage drive respectively identified by the source ID and the destination ID included in a same third element are of a same storage type, have a same capacity, and have mounting date and times with a difference within a predetermined period of time.

8. The storage control device according to claim 7, wherein
the processor is configured to
include, in the same third element, buffer ID identifying a buffer storage drive which is of the same storage type as the source storage drive and the destination storage drive, which has the same capacity as the source storage drive and the destination storage drive, and whose ID is not yet included in any third element.

9. The storage control device according to claim 5, wherein
the processor is further configured to
obtain access time points of the respective storage drives,
estimate, based on the access time points, time zones available for performing the replacement,
estimate, based on the estimated time zones, completion date and time when the replacement is to be completed for leading N elements (N is a natural number) of the third list,
generate a correspondence table in which each of numbers 1 to N is associated with corresponding completion date and time,
notify a user of the correspondence table, and
receive a number M (M is a natural number) specified by the user in response to the notification, and
the processor is configured to
perform the replacement for leading M elements of the third list.

10. The storage control device according to claim 5, wherein
the processor is further configured to
obtain access time points of the respective storage drives,
estimate, based on the access time points, time zones available for performing g the replacement,
start or restart the replacement when one of the estimated time zones is entered, and
temporarily stop the replacement when the one of the estimated time zones is escaped.

11. The storage control device according to claim 10, wherein
the processor is further configured to
temporarily stop the replacement when one of the storage drives subjected to the replacement is accessed for writing during the replacement, and
restart the replacement after the access for writing is completed.

12. The storage control device according to claim 5, wherein
the processor is configured to
perform the replacement by
performing first copy of copying data of the source storage drive to the buffer storage drive,
performing first exchange of exchanging the buffer storage drive and the source storage drive with each other after the first copy,
performing second copy of copying data of the destination storage drive to the source storage drive after the first exchange,
performing second exchange of exchanging the source storage drive and the destination storage drive with each other after the second copy,
performing third copy of copying data of the buffer storage drive to the destination storage drive after the second exchange, and
performing third exchange of exchanging the destination storage drive and the buffer storage drive with each other after the third copy.

13. A storage device, comprising:
a plurality of storage drives; and
a processor configured to
monitor driving states of each of the plurality of storage drives, and
rearrange data stored in the storage drives so that the driving states of the storage drives are uniformed.

14. The storage device according to claim 13, wherein
the processor is configured to
monitor, as the driving states, one or more types of driving state values correlating with deterioration of the storage drives.

15. The storage device according to claim 14, wherein
the processor is configured to
monitor, as the driving state values, at least one of
a number of times power of each storage drive is turned off/on,
a number of times a driving motor of each storage drive is turned off/on,
a number of times spin-up or spin-down is performed by the driving motor, and
a number of times each storage drive is accessed.

16. The storage device according to claim 14, wherein
the processor is configured to
select, based on the driving state values, two storage drives which have driving states different from each other, and
replace data stored in the selected two storage drives with each other.

17. The storage device according to claim 14, wherein
the processor is configured to
calculate a deviation value of the driving state values of each storage drive for each type of the driving state values,
generate a first list having first elements each including first identification information (ID) for identifying a first storage drive, a first deviation value, and type information in association with one another, the first deviation value being largest among deviation values calculated for the first storage drive, the type information representing a type of a first driving state value corresponding to the first deviation value, the first elements being sorted in descending order of the first deviation value,
generate, for each type of the driving state values, a second list having second elements each including second ID for identifying a second storage drive and a second driving state value of the second storage drive in association with each other, the second elements being sorted in ascending order of the second driving state value,
generate, based on the first list and the second lists, a third list having third elements each including source ID, destination ID, and buffer ID in association with one another, the source ID identifying a source storage drive, the destination ID identifying a destination storage drive, the buffer ID identifying a buffer storage drive used for replacement of data between the source storage drive and the destination storage drive, and
perform the replacement in an order of the third elements, based on the source ID, the destination ID, and the buffer ID included in each third element.

18. The storage device according to claim 17, wherein
the processor is further configured to
obtain access time points of the respective storage drives,
estimate, based on the access time points, time zones available for performing the replacement,
estimate, based on the estimated time zones, completion date and time when the replacement is to be completed for leading N elements (N is a natural number) of the third list,
generate a correspondence table in which each of numbers 1 to N is associated with corresponding completion date and time,
notify a user of the correspondence table, and
receive a number M (M is a natural number) specified by the user in response to the notification, and
the processor is configured to
perform the replacement for leading M elements of the third list.

19. The storage device according to claim 17, wherein
the processor is further configured to
obtain access time points of the respective storage drives,
estimate, based on the access time points, time zones available for performing the replacement,
start or restart the replacement when one of the estimated time zones is entered, and
temporarily stop the replacement when the one of the estimated time zones is escaped.

20. A computer-readable recording medium having stored therein a program for causing a computer to execute a process, the process comprising:
monitoring driving states of each of a plurality of storage drives included in a storage device; and
rearranging data stored in the storage drives so that the driving states of the storage drives are uniformed.
